(19) United States
(12) Patent Application Publication
(10) Pub. No.: US 2013/0131968 A1
(43) Pub. Date: May 23, 2013

(54) TRANSPORTATION SCHEDULING SYSTEM AND METHOD

(71) Applicant: Mitchell Scott Wills, Melbourne, FL (US)

(72) Inventor: Mitchell Scott Wills, Melbourne, FL (US)

(21) Appl. No.: 13/303,555

(22) Filed: Nov. 23, 2011

(51) Int. Cl. G08G 9/00; G06Q 10/06

(52) U.S. Cl. 701/117; 705/7.12

(57) ABSTRACT

A system includes an energy module and a scheduling module. The energy module is configured to determine a first consumption parameter representative of a first amount of energy that is projected to be expended by a first vehicle during an upcoming movement event involving the first vehicle. The energy module is configured to determine the first consumption parameter as the first vehicle moves along a route toward a destination location and prior to the first vehicle taking part in the upcoming movement event. The scheduling module is configured to receive the first consumption parameter from the energy module and to at least one of create or modify a first schedule for the first vehicle to move along the route based on the first consumption parameter.

### BACKGROUND

A transportation network for vehicles can include several interconnected main routes on which separate vehicles travel between locations. For example, a transportation network may be formed from interconnected railroad tracks with rail vehicles traveling along the tracks. The vehicles may travel according to schedules that dictate where and when the vehicles are to travel in the transportation network. The schedules may be coordinated with each other in order to arrange for certain vehicles to arrive at various locations in the transportation network at desired times and/or in a desired order.

As the vehicles travel through the transportation network, one or more of the vehicles may encounter situations where a vehicle is required to slow down and/or stop. For example, if a vehicle approaches a reduced speed limit of a route (e.g., due to maintenance or repair of the route), then the vehicle may need to reduce speed to travel through the route. If two vehicles are traveling toward each other on the same route, one of the vehicles may need to pull off onto a siding section of the route to allow the other vehicle to pass on the route. A vehicle approaching a raised bridge may need to slow down and/or stop to allow the bridge to lower before crossing the bridge. After the vehicles have slowed down and/or stopped, the vehicles accelerate to continue traveling along the routes to scheduled destination locations.

Due to the varying sizes of vehicles, different amounts of energy and/or fuel may be expended by different vehicles to accelerate after slowing down and/or stopping. If the schedules of the vehicles are established so that the larger and/or heavier vehicles are the vehicles that slow down and/or stop, then larger amounts of energy and/or fuel may be consumed in accelerating these vehicles relative to accelerating smaller and/or lighter vehicles after slowing and/or stopping. Moreover, larger and/or heavier vehicles may take longer to accelerate after slowing and/or stopping, which can slow the travel of the vehicle and other vehicles in the transportation network.

A need exists to coordinate and/or control travel of vehicles in a transportation network such that the amounts of fuel consumed by the vehicles are reduced and/or the flow of travel through the transportation network is improved.

### BRIEF DESCRIPTION

In one embodiment, a system (e.g., a transportation scheduling system) is provided that includes an energy module and a scheduling module. The energy module is configured to determine a first consumption parameter representative of a first amount of energy expended by a first vehicle during a movement event involving the first vehicle as the first vehicle moves along a route toward a destination location. For example, the energy module may be configured to determine the first consumption parameter as representative of a first amount of energy projected or estimated to be expended by the first vehicle when the first vehicle encounters (takes part in) the movement event at a future point in time, based on how the vehicle would experience the movement event according to its current operating mode or trajectory. The scheduling module is configured to receive the first consumption parameter from the energy module and to at least one of create or modify a first schedule for the first vehicle to move along the route based on the first consumption parameter. In another embodiment, another system is provided that includes an energy module and a scheduling module. The energy module is configured to determine a first consumption parameter representative of a first amount of energy that is projected to be expended by a first vehicle during an upcoming movement event involving the first vehicle. The energy module is configured to determine the first consumption parameter as the first vehicle moves along a route toward a destination location and prior to the first vehicle taking part in the upcoming movement event. The scheduling module is configured to receive the first consumption parameter from the energy module and to at least one of create or modify a first schedule for the first vehicle to move along the route based on the first consumption parameter.

In another embodiment, another system (e.g., a transportation scheduling system) is provided that includes an energy module and a scheduling module. The energy module is configured to determine a first consumption parameter representative of a first amount of energy that is projected to be expended by a first vehicle during an upcoming movement event involving the first vehicle. The energy module is configured to determine the first consumption parameter as the first vehicle moves along a route toward a destination location and prior to the first vehicle taking part in the upcoming movement event. The scheduling module is configured to receive the first consumption parameter from the energy module and to at least one of create or modify a first schedule for the first vehicle to move along the route based on the first consumption parameter.

In another embodiment, a method (e.g., a method for transportation scheduling) is provided that includes determining a first consumption parameter that is representative of a first amount of energy expended by a first vehicle during a movement event involving the first vehicle as the first vehicle moves along a route toward a destination location. For example, the first consumption parameter may be representative of a first amount of energy that is projected or estimated to be expected by the first vehicle when the first vehicle takes part in the movement event at a future point in time. The method also includes creating or modifying a first schedule for the first vehicle to move along the route based on the first consumption parameter. In another embodiment, another method is provided that includes determining a first consumption parameter that is representative of a first amount of energy that is projected to be expended by a first vehicle during an upcoming movement event involving the first vehicle. The first amount of energy is determined as the first vehicle moves along a route toward a destination location and prior to the first vehicle taking part in the upcoming movement event. The method also includes creating or modifying a first schedule for the first vehicle to move along the route based on the first consumption parameter.

In another embodiment, another system (e.g., a transportation scheduling system) is provided that includes a control module. The control module is configured to be disposed on-board a first vehicle and communicatively coupled with at least one of a propulsion subsystem of the first vehicle or an output device disposed on-board the first vehicle. The control module is configured to receive an output signal from a scheduling module that generates the output signal based on a consumption parameter associated with the first vehicle. The consumption parameter is based on an amount of energy that is projected to be expended by the first vehicle during an upcoming movement event involving the first vehicle as the first vehicle moves along a route from a starting location to a destination location and prior to the first vehicle taking part in the upcoming movement event. The control module is configured to at least one of automatically control movement of the first vehicle or provide a notification to an operator of the first vehicle using the output device to direct the operator to control the movement of the first vehicle based on the output signal.

In another embodiment, another system (e.g., a transportation scheduling system) that includes a control module is provided. The control module is configured to be communicatively coupled with a wayside device that is disposed alongside a route traveled by a first vehicle. The control module also is configured to receive an output signal from a scheduling module that generates the output signal based on a consumption parameter associated with the first vehicle. The consumption parameter is based on an amount of energy that is projected to be expended by the first vehicle during an upcoming movement event involving the first vehicle as the first vehicle moves along the route from a starting location to a destination location and prior to the first vehicle taking part in the upcoming movement event. The control module also is configured to at least one of generate a signal or actuate a change in the route to provide a notification to an operator of the first vehicle to direct the operator to control the movement of the first vehicle based on the output signal.

Another embodiment relates to a method, e.g., the method may be carried out by a system as described here, which is configured for performing the method. The method comprises a step of determining an estimated amount of energy that would be expended by a first vehicle (train, or rail vehicle, or other vehicle) upon taking part in a forthcoming movement event, as the first vehicle moves in a transportation network. For example, the forthcoming movement event could be a scheduled slowdown or stop at a moveable bridge, or a scheduled slowdown or stop at a siding to accommodate a meet-and-pass or overtake with a second vehicle. The amount of energy may be estimated as described above, e.g., based on the mass of the vehicle and change in velocity, or another method. The method further comprises a step of generating a control signal for controlling at least one of a second vehicle traveling in the network or a wayside device. The control signal is generated based on the estimated amount of energy, and is configured for the first vehicle to expend less energy during the movement event than the estimated amount when the second vehicle or wayside device is controlled according to the control signal and the first vehicle is controlled in coordination with the second vehicle or wayside device. Here, “configured” means timed and/or having control content such that if the second vehicle or wayside device is controlled according to the control signal, this allows (facilitates) the first vehicle to be controlled, in coordination, to use less energy (than the estimated amount) during the movement event.

In another embodiment of the method (e.g., a method for transportation scheduling), the method comprises a step of determining a first estimated amount of energy that would be expended by a first vehicle upon taking part in a forthcoming movement event, and a second estimated amount of energy that would be expended by a second vehicle upon taking part in the forthcoming movement event. The method further comprises a comparison between the first estimated amount and the second estimated amount (the method comprises comparing the first estimated amount and the second estimated amount), and generating a first control signal for controlling the first vehicle (relative to the movement event) based on the comparison. The first control signal is configured such that when the first vehicle is controlled according to the control signal, the first vehicle expends less energy than the first estimated amount during the movement event. The method may further comprise generating a second control signal for controlling the second vehicle, in coordination with how the first vehicle is controlled according to the first control signal. The comparison may include an assessment of how adjusting movement of the first vehicle and/or the second vehicle, with respect to the movement event, would result in the most energy saved and/or the most economic value (money saved) versus the first estimated amount and the second estimated amount.

In another embodiment of a method (e.g., a method for transportation scheduling), the method comprises determining a first estimated amount of energy to be expended by a first vehicle during a forthcoming movement event in a transportation network. The first estimated amount is determined based on a first schedule or trajectory of the first vehicle. The method further comprises, based on a second schedule or trajectory of a second vehicle, determining a second estimated amount of energy to be expended by the second vehicle during the forthcoming movement event. The method further comprises determining a change in the first schedule or trajectory that would result in the first vehicle expending a third estimated amount of energy during the movement event that is less than the first estimated amount. The method further comprises determining a fourth estimated amount of energy that would be expended by the second vehicle during the movement event if controlled to account for the change in the first schedule or trajectory. The method further comprises generating a control signal for controlling the first vehicle according to the change in the first schedule or trajectory, but only if a total amount of energy or a total value of the third and fourth estimated amounts in combination is less than a total amount of energy or a total value of the first and second estimated amounts in combination.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of one embodiment of a transportation network;

FIG. 2 is a schematic diagram of one embodiment of a scheduling system shown in FIG. 1;

FIG. 3 is a schematic diagram of one embodiment of a vehicle shown in FIG. 1;

FIG. 4 is an illustration of energy profiles for two vehicles during a movement event in accordance with one example;

FIG. 5 is an illustration of fuel consumption profiles for the vehicles during the movement event represented in FIG. 4;

FIG. 6 is an illustration of speed profiles for a vehicle during a movement event in accordance with another example;

FIG. 7 is an illustration of fuel consumption profiles associated with the speed profiles shown in FIG. 6;

FIG. 8 is an illustration of energy profiles for a vehicle during a movement event in accordance with another example;

FIG. 9 is an illustration of fuel consumption profiles associated with the energy profiles shown in FIG. 9;

FIG. 10 is a schematic diagram of one embodiment of a control device and wayside devices;

FIG. 11 is a flowchart of one embodiment of a method for scheduling movement of vehicles in a transportation network; and

FIG. 12 is a flowchart of one embodiment of a method for controlling movement of vehicles in a transportation network.

### DETAILED DESCRIPTION

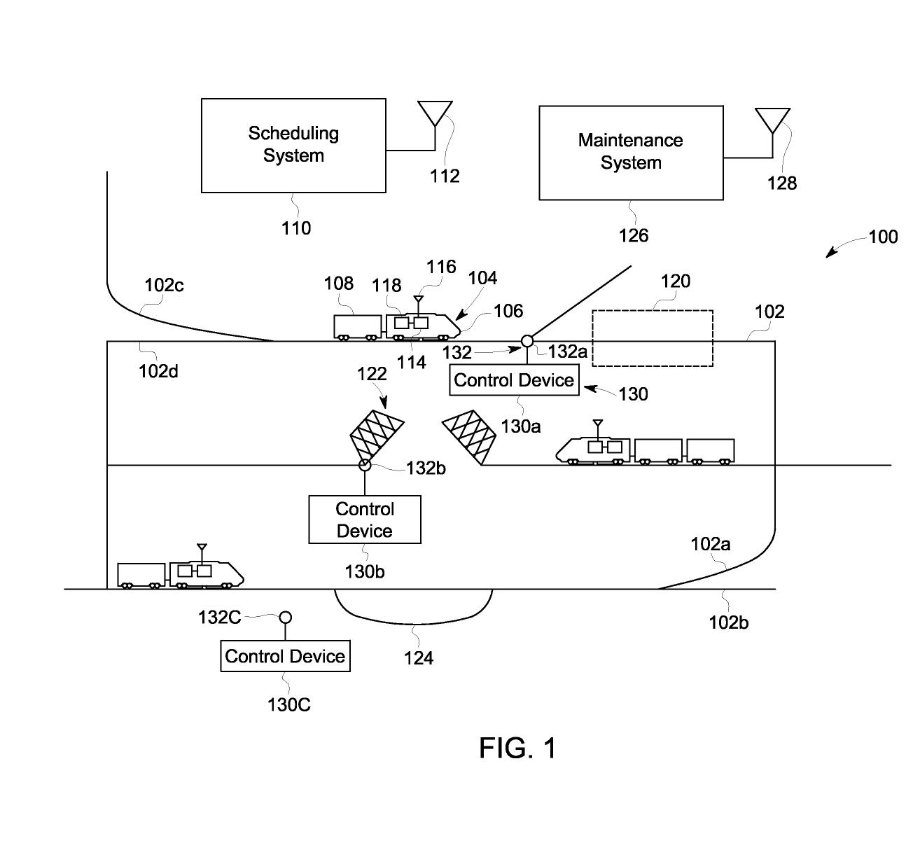

FIG. 1 is a schematic diagram of one embodiment of a transportation network 100. The transportation network 100 includes a plurality of interconnected routes 102, such as railroad tracks, roads, or other paths across which vehicles travel. The transportation network 100 may extend over a relatively large area, such as hundreds of miles or kilometers of land area. While only one transportation network 100 is shown in FIG. 1, one or more other transportation networks 100 may be joined with and accessible to vehicles traveling in the illustrated transportation network 100. For example, one or more of the routes 102 may extend to another transportation network 100 such that vehicles can travel between the transportation networks 100. Different transportation networks 100 may be defined by different geographic boundaries, such as different towns, cities, counties, states, groups of states, countries, continents, and the like. The number of routes 102 shown in FIG. 1 is meant to be illustrative and not limiting on all embodiments of the described subject matter. Moreover, while one or more embodiments described herein relate to a transportation network formed from railroad tracks, not all embodiments are so limited. One or more embodiments may relate to transportation networks in which vehicles other than rail vehicles travel, such as other off-highway vehicles, automobiles, marine vessels, airplanes, and the like.

Several vehicles 104 travel along the routes 102 in the transportation network 100. The vehicles 104 may concurrently travel in the transportation network 100 along the same or different routes 102. Travel of one or more vehicles 104 may be constrained to travel within the transportation network 100 (referred to herein as “intra-network travel”). Alternatively, one or more of the vehicles 104 may enter the transportation network 100 from another transportation network or leave the transportation network 100 to travel into another transportation network (referred to herein as “inter-network travel”). In the illustrated embodiment, the vehicles 104 are shown and described herein as rail vehicles or rail vehicle consists. (A consist is a group of vehicles that are mechanically linked to travel together.) However, one or more other embodiments may relate to vehicles other than rail vehicles or rail vehicle consists. While three vehicles 104 are shown in FIG. 1, alternatively, a different number of vehicles 104 may be concurrently traveling in the transportation network 100.

A vehicle 104 may include a group of powered units 106 (e.g., locomotives or other vehicles capable of self-propulsion) and/or non-powered units 108 (e.g., cargo cars, passenger cars, or other vehicles incapable of self-propulsion) that are mechanically coupled or linked together to travel along the routes 102, i.e., a consist. The routes 102 are interconnected to permit the vehicles 104 to travel over various combinations of the routes 102 to move from a starting location to a destination location. The vehicles 104 may travel along the routes 102 according to a movement plan of the transportation network 100. The movement plan coordinates movement of the vehicles 104 in the transportation network 100. For example, the movement plan may include schedules for the vehicles 104 to move from a starting location or a current location to a destination location at a scheduled arrival time. The schedules may dictate a destination location and the scheduled arrival time for a vehicle 104. Alternatively, the schedules may include one or more intermediate events for the vehicle 104 prior to reaching the destination location at the scheduled arrival time, such as a location and/or time for the vehicle 104 to stop and refuel.

In one embodiment, the movement plan includes a list, table, or other logical arrangement of scheduled geographic locations (e.g., Global Positioning System coordinates) within the transportation network 100 and associated scheduled arrival times. The vehicles 104 move along various paths within the transportation network 100 to arrive at the scheduled locations at the associated scheduled arrival times. The scheduled locations in the movement plan can be referred to as “scheduled waypoints.”

The movement plan can be based on starting locations or current locations, and/or destination locations of the vehicles 104. For example, a schedule may be developed for one or more of the vehicles 104 that directs the vehicle 104 where and when to move within the transportation network 100 to arrive at a destination from the starting location or current location of the vehicle 104. In one embodiment, a schedule for a vehicle 104 includes a destination location and a scheduled arrival time. The vehicle 104 may travel according to the schedule to arrive at the destination location at the scheduled arrival time. In another embodiment, a schedule for a vehicle 104 may include several scheduled waypoint locations located between the starting location or the current location of the vehicle 104 and a destination location of the vehicle 104, along with scheduled arrival times associated with the waypoint locations.

The movement plan may be determined by a scheduling system 110. As shown in FIG. 1, the scheduling system 110 can be disposed off-board (e.g., outside) the vehicles 104. For example, the scheduling system 110 may be disposed at a central dispatch office for a railroad company. The scheduling system 110 can create and communicate the schedules to the vehicles 104. The scheduling system 110 can include a wireless antenna 112 (and associated transceiver equipment), such as a radio frequency (RF) or cellular antenna, that wirelessly transmits the schedules to the vehicles 104. For example, the scheduling system 110 may transmit destination locations and associated arrival times to the vehicles 104.

The vehicles 104 include control systems 114 disposed on-board the vehicles 104. The control systems 114 receive the schedules from the scheduling system 110 and generate output signals that may be used to control propulsion of the vehicles 104 through the transportation network 100. For example, the vehicles 104 may include wireless antennas 116 (and associated transceiver equipment), such as RF or cellular antennas, that receive the schedules from the scheduling system 110. The wireless antenna 116 communicates the received schedule to the control system 114 that may be disposed on-board the vehicle 104. The control system 114 examines the schedule, such as by determining the scheduled destination location and scheduled arrival time, and generates output signals based on the schedule.

The output signals may be used to automatically control tractive efforts and/or braking efforts of the vehicle 104 such that the vehicle 104 self-propels along the routes 102 to the destination location. For example, the control system 114 may be operatively coupled with a propulsion subsystem 118 of the vehicle 104. The propulsion subsystem 118 may include motors (such as traction motors), engines, brakes (such as air brakes and/or regenerative brakes), and the like, that generate tractive energy to propel the vehicle 104 and/or slow movement of the vehicle 104. The control system 114 may generate output signals that automatically control the propulsion subsystem 118, such as by automatically changing throttle settings and/or brake settings of the propulsion subsystem 118.

In another embodiment, the output signals may be used to prompt an operator of the vehicle 104 to manually control the tractive efforts and/or braking efforts of the vehicle 104. For example, the control system 114 may include an output device, such as a computer monitor, touchscreen, acoustic speaker, or the like, that generates visual and/or audible instructions based on the output signals. The instructions may direct the operator to manually change throttle settings and/or brake settings of the propulsion subsystem 118.

In one embodiment, the control system 114 may form a trip plan for a trip of the vehicle 104 to travel to a scheduled destination location at a scheduled arrival time. The trip plan may include throttle settings, brake settings, designated speeds, or the like, of the vehicle 104 for various sections of the trip of the vehicle 104. For example, the trip plan can include one or more velocity curves that designate various speeds of the vehicle 104 along various sections of the routes 102. The trip plan can be formed based on a trip profile associated with an upcoming trip of a vehicle 104. The trip profile can include information related to the vehicle 104, the routes 102 over which the vehicle 104 will traverse during the upcoming trip, and/or other information. The information related to the vehicle 104 can include the type of vehicle 104, the tractive energy generated by powered units 106 in the vehicle 104, the weight or mass of the vehicle 104 and/or cargo being carried by the vehicle 104, the length and/or other size of the vehicle 104 (e.g., how many powered and non-powered units 106, 108 are mechanically coupled with each other in the vehicle 104), and the like. The information related to the route 102 can include the curvature, grade (e.g., inclination), existence of ongoing repairs, speed limits, and the like, for one or more sections of the route 102. The other information can include information related to conditions that impact how much fuel the vehicles 104 consume while traveling, such as the air pressure, temperature, humidity, and the like. The control system 114 may form the output signals based on the trip plan.

In one embodiment, the trip plan is formed by the control system 114 to reduce an amount of fuel that is consumed by the vehicle 104 and/or to reduce an amount of emissions generated by the vehicle 104 as the vehicle 104 travels to the destination location associated with the received schedule. As used herein, the term “fuel” may refer to one or more different types of fuel, such as diesel fuel, gasoline, natural gas, hydrogen, electric energy (e.g., current), and the like. The control system 114 may create a trip plan having throttle settings, brake settings, designated speeds, or the like, that propels the vehicle 104 to the scheduled destination location in a manner that consumes less fuel and/or generates less emissions than if the vehicle 104 traveled to the scheduled destination location in another manner. As one example, the vehicle 104 may consume less fuel and/or generate fewer emissions in traveling to the destination location according to the trip plan than if the vehicle 104 traveled to the destination location while traveling at another predetermined speed, such as the maximum allowable speed of the routes 102 (which may be referred to as “track speed”). The trip plan may result in the vehicle 104 arriving at the scheduled destination later than the scheduled arrival time. For example, following the trip plan may cause the vehicle 104 to arrive later than the scheduled arrival time, but within a predetermined range of time after the scheduled arrival time.

In the illustrated embodiment, a maintenance system 126 is provided that controls when one or more sections or areas of the transportation network 100 are repaired and/or maintained. As shown in FIG. 1, the maintenance system 126 can be disposed off-board the vehicles 104, such as by being disposed at a central dispatch office for a railroad company or other building. The maintenance system 126 can schedule work crews to repair and/or maintain various sections of the routes 102. The maintenance system 126 can include a wireless antenna 128, such as a radio frequency (RF) or cellular antenna, that wirelessly communicates with work crews working on the routes 102 and/or with the scheduling system 110 and/or vehicles 104 to report when and where the routes 102 may be under repair (e.g., so as to define a slow region 120 described below).

One or more control devices 130 are communicatively coupled with wayside devices 132 disposed within the transportation network 100. The control devices 130 may communicate output signals to the wayside devices 132 to control the wayside devices 132. The wayside devices 132 can include signaling devices that provide signals to operators of the vehicles 104 and/or other devices that change the routes 102. For example, with respect to signaling devices, the wayside devices 132 can include visual signals that communicate warnings to operators of the vehicles 104, such as by illuminating differently colored lights to notify the vehicles 104 to slow down and/or stop. With respect to other types of devices, the wayside devices 132 can include switches that couple and/or decouple different segments of the routes 102 to control which routes a vehicle 102 travels along.

The schedules of one or more vehicles 104 may include movement events that involve the vehicles 104. In one embodiment, the movement event includes travel of one or more vehicles 104 that deviates from the vehicles 104 traveling at a designated speed, such as a speed limit (e.g., track speed) of the routes 102. For example, a movement event can include an event that involves a vehicle 104 slowing down and/or stopping when the vehicle 104 otherwise (e.g., outside of the movement event) would proceed without slowing down and/or stopping.

Examples of movement events can include singular events that involve a single vehicle 104 and interactions that involve multiple vehicles 104. A singular event can be a vehicle 104 slowing down when approaching and/or traveling through a slow region 120 of the transportation network 100. A slow region 120 includes one or more sections or areas of the routes 102 having a lower speed limit than other areas or the remainder of the routes 102 due to one or more conditions, such as a slow order, ongoing maintenance or repair of the routes 102, damage to the routes 102, and the like. Another example of a singular event may include a vehicle 104 slowing down and/or stopping for a portion of a route 102 that is at least temporarily unavailable for travel. As shown in FIG. 1, one or more of the routes 102 can include a bridge 122, such as a drawbridge, swing bridge, or other moveable bridge, that occasionally or periodically raises for a temporary amount of time to allow other vehicles to pass beneath the bridge 122. One or more vehicles 104 may slow down or stop to allow the bridge 122 to lower from a raised position so that the vehicles 104 can travel across the bridge 122.

An interaction between two or more vehicles 104 can include an approaching event, a meet event, a pass event (which also may be referred to as an overtake), a divergence event, and/or a convergence event (which also may be referred to as a merge). The schedules can include movement events between two or more vehicles 108. A movement event includes coordinated travel of the two or more vehicles 108 at a location to avoid the vehicles 108 hitting each other or coming within a designated safety distance of each other. Examples of movement events include meet events, pass events, divergence events, and convergence events.

A meet event involves a first vehicle 104 and a second vehicle 104 concurrently traveling in opposite directions along the same route 102. The first vehicle 104 pulls off of the route 102 onto a siding section route 124 that is joined with the route 102. The first vehicle 104 may slow down and/or stop on the siding section route 124 while the second vehicle 104 passes the first vehicle 104 on the route 102. Once the second vehicle 104 has passed, the first vehicle 104 may re-accelerate and pull back onto the route 102 from the siding section route 124 and continue to travel along the route 102 in an opposite direction as the second vehicle 104.

A pass event involves a first vehicle 104 and a second vehicle 104 concurrently traveling in the same or a common direction along the same route 102, with the first vehicle 104 leading the second vehicle 104 along the route 102. The first vehicle 104 pulls onto a siding section route 124 and slows down and/or stops. The second vehicle 104 continues along the route 102 and passes the first vehicle 104 to pass on the route 102. The first vehicle 104 may then re-accelerate and pull back onto the route 102 and follow the second vehicle 104.

A divergence event involves a first vehicle 104 and a second vehicle 104 concurrently traveling in the same direction on the same or a common route 102 that splits into two or more diverging routes 102 (e.g., shown as routes 102a, 102b in FIG. 1). The first vehicle 104 may lead the second vehicle 104 and may pull off of the common route 102 onto the first route 102a of the diverging routes 102a, 102b. The second vehicle 104 may pull off of the common route 102 onto a different, second route 102b of the diverging routes 102a, 102b after the first vehicle 104 has pulled onto the first diverging route 102a.

A convergence event involves a first vehicle 104 and a second vehicle 104 concurrently traveling on different routes 102 (e.g., shown as routes 102c, 102d in FIG. 1) that converge into a common route 102, with the first and second vehicles 104 concurrently traveling toward the common route 102. The first vehicle 104 may pull onto the common route 102 ahead of the second vehicle 104 so that the first and second vehicles 104 continue to travel in the same direction along the common route 102.

The movement events may be included in the schedules of the vehicles 104 by the scheduling system 110 directing the vehicles 104 to travel to destinations associated with the events (e.g., to the siding section route 124, the bridge 122, the slow region 120, the common route 102 from converging routes 102c, 102d, the diverging routes 102a, 102b from the common route 102, and the like) at associated arrival times. The schedules may direct the vehicles 104 to slow down and/or stop, such as to permit another vehicle 104 to pass, to allow the bridge 122 to lower, to comply with a lower speed limit in the slow region 120, to allow another vehicle 104 to pull onto a common route 102 during a merge, to allow another vehicle 104 to pull onto a diverging route 102a or 102b, and the like, as described above. Following the scheduled movement events, the vehicles 104 that slowed down and/or stopped may then accelerate back up to a designated speed, such as a speed limit of the route 102.

Different vehicles 104 may expend different amounts of energy to slow down and/or stop, and/or to accelerate after slowing down and/or stopping. For example, a larger, first vehicle 104 (e.g., a vehicle 104 having more mass than another vehicle 104) may lose more kinetic energy when slowing down and/or stopping for a movement event than a smaller, second vehicle 104 (e.g., a vehicle 104 having smaller mass). As one non-limiting example, a train having a larger number of locomotives and/or railcars, a larger amount of cargo and/or passengers, and/or larger locomotives and/or railcars may lose more kinetic energy when slowing down and/or stopping on a siding section route 124 than another train having a smaller number of locomotives and/or railcars, a smaller amount of cargo and/or passengers, and/or smaller locomotives and/or railcars. Similarly, larger (more massive) vehicles 104 may expend more energy in order to accelerate back up to a designated speed, such as the speed limit of a route 102. As the amount of energy expended to accelerate back up to a speed that a vehicle 104 was traveling prior to a movement event increases, the amount of fuel consumed by that vehicle 104 also may increase.

In one embodiment, the scheduling system 110 forms and/or modifies schedules that include movement events for one or more of the vehicles 104 based on a consumption parameter of one or more of the vehicles 104. The consumption parameter may represent an amount of energy that is projected to be expended by one or more vehicles 104 during a movement event. By “projected,” it is meant that, in one embodiment, the consumption parameter for a vehicle includes or is based on a calculated or estimated amount of energy that will be or is likely to be (e.g. more likely than not) expended by the vehicle 104 when the vehicle 104 takes part in the movement event. For example, a consumption parameter may represent the calculated or estimated amount of kinetic energy that may be lost by a vehicle 104 in slowing down and/or stopping for a movement event, an amount of fuel that is calculated or estimated to be consumed by the vehicle 104 in accelerating up to a speed limit of a route 102 after slowing down and/or stopping for a movement event, and the like. Alternatively, the consumption parameter may represent a mass or relative size of the vehicle 104 (which may be related to the kinetic energy lost and/or fuel consumed in connection with a movement event, as described above).

The scheduling system 110 can determine which of a plurality of vehicles 104 that participate in a movement event is the vehicle 104 that slows down and/or stops and which of the vehicles 104 does not slow down or stop (or slows down to a lesser extent) based on consumption parameters for one or more of the vehicles 104, as described below. The scheduling system 110 may examine the consumption parameters and schedule the vehicle 104 having the lower consumption parameter (e.g., the vehicle 104 having the lower mass, that is projected to expend less kinetic energy, and/or is projected to consume less fuel in connection with a movement event) to slow down and/or stop for a movement event involving two or more vehicles 104.

The scheduling system 110 can determine whether to re-schedule or delay a movement event that involves a vehicle 104 based on the consumption parameter of the vehicle 104. For example, the scheduling system 110 may determine to delay the raising of the bridge 122, the start of a slow order associated with a slow region 120, and the like, based on the consumption parameter of a vehicle 104 that is scheduled to travel over the bridge 122 or through the slow region 120. If a consumption parameter of a vehicle 104 is sufficiently large (e.g., is greater than a designated threshold or is larger than a consumption parameter of another vehicle 104 scheduled to concurrently participate in the same movement event by at least a designated amount), then the scheduling system 110 may delay raising the bridge 122 and/or starting maintenance on a route 102 until after the vehicle 104 is scheduled to pass over the bridge 122 or through the slow region 120. In one embodiment, the scheduling system 110 may transmit an output signal to the maintenance system 128 that directs the maintenance system 128 to delay the start of maintenance or repair to a section of the route 102. In another embodiment, the scheduling system 110 can transmit output signals to the vehicles 104 to automatically or manually control the tractive efforts and/or braking efforts of the vehicles 104 based on the consumption parameters.

In another example, the control devices 130 can generate output signals for the wayside devices 132 based on the consumption parameters of the vehicles 104. A first control device 130a may control a first wayside device 132a that includes a switch to direct a vehicle 104 to travel on another route 102 that does not include the slow region 120 based on the consumption parameter of the vehicle 104. For example, if the consumption parameter associated with the vehicle 104 slowing down for the slow region 120 is sufficiently large (e.g., exceeds a designated threshold), then the first control device 130a may generate a output signal and transmit (e.g., via one or more wired and/or wireless connections) the output signal to the first wayside device 132a. The output signal may direct the first wayside device 132a to activate a switch to cause the vehicle 104 to travel on a route 102 that does not include the slow region 120.

In another example, a second control device 130b may generate an output signal for a second wayside device 132b that directs the second wayside device 132b to delay raising the bridge 122. The second control device 130b can generate such as output signal to avoid raising the bridge 122 until a vehicle 104 having a relatively large consumption parameter (e.g., that exceeds a threshold) passes over the bridge 122.

In another example, a third control device 130c may generate an output signal for a third wayside device 132c. The output signal may direct the third wayside device 132c to generate a signal (e.g., an illuminated light) that visually directs an operator of a vehicle 104 to slow down. For example, the output signal may cause the third wayside device 132c to direct an operator of the vehicle 104 having a relatively large consumption parameter to slow down in advance of approaching too closely to another vehicle 104. As described below, directing a first, heavier vehicle 104 to slow down before approaching too closely to a second vehicle 104 can avoid having to cause the heavier vehicle 104 from more abruptly slowing down when the heavier vehicle 104 approaches the second vehicle 104.

By changing which vehicles 104 slow down and/or stop, or by avoiding movement events involving vehicles 104 having large consumption parameters, the amount of fuel consumed by the vehicles 104 in the transportation network 100 can be decreased. Additionally, keeping the heavier vehicles 104 (having the larger consumption parameters) moving instead of slowing down and/or stopping and then slowly accelerating can increase the movement of other vehicles 104 in the transportation network 100 by reducing traffic congestion in the transportation network 100.

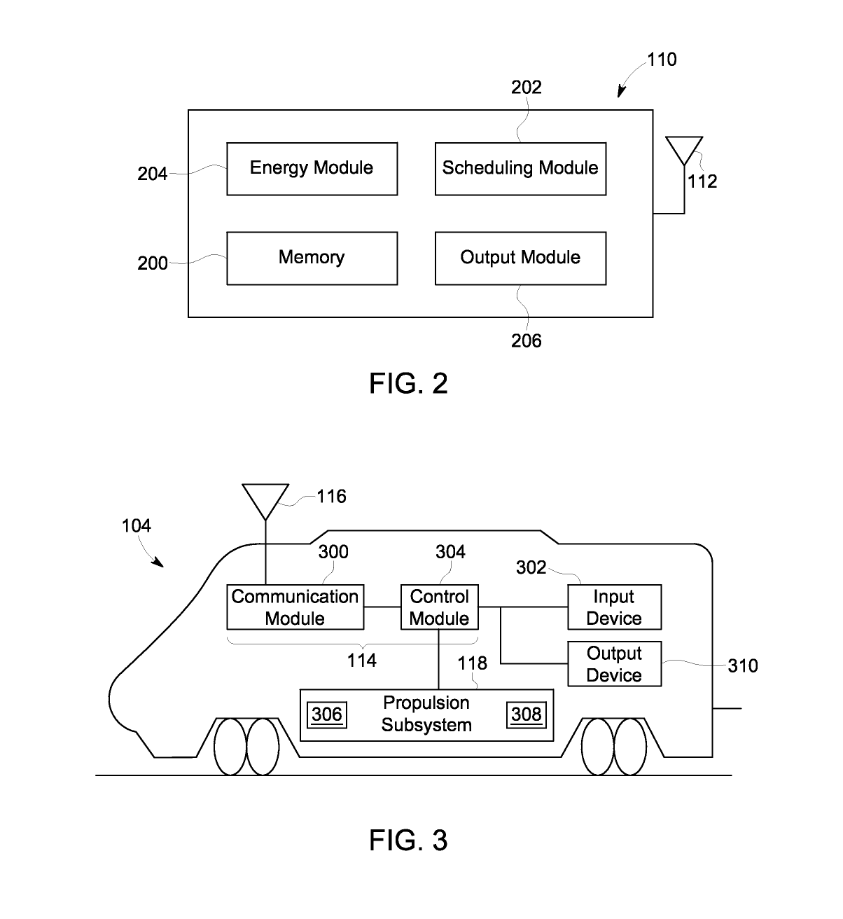

FIG. 2 is a schematic diagram of one embodiment of the scheduling system 110. The scheduling system 110 includes several modules perform operations based on one or more sets of instructions (e.g., software). The instructions on which the modules operate may be stored on a tangible and non-transitory (e.g., not a transient signal) computer readable storage medium, such as a memory 200. The memory 200 may include one or more computer hard drives, flash drives, random access memory (RAM), read only memory (ROM), electrically erasable programmable read only memory (EEPROM), and the like. Alternatively, one or more of the sets of instructions that direct operations of the modules may be hard-wired into the logic of the modules. Although not shown in FIG. 2, the modules may be communicatively coupled with each other such that the modules are able to communicate information and/or data between the modules by one or more wired and/or wireless connections, such as wires, cables, busses, wireless networks, and the like.

The scheduling system 110 includes a scheduling module 202 that creates schedules for the vehicles 104 (shown in FIG. 1). The scheduling module 202 can form the movement plan for the transportation network 100 (shown in FIG. 1) that coordinates the schedules of the various vehicles 104 traveling in the transportation network 100. For example, the scheduling module 202 may generate schedules for the vehicles 104 that are based on each other so that the vehicles 104 do not collide or come within a designated safety distance from each other. The scheduling module 202 can include one or more movement events described above in order to coordinate the movements of the vehicles 104 and to cause the vehicles 104 to travel to various destination locations at associated arrival times.

As described above, the scheduling module 202 may generate and/or modify schedules of the vehicles 104 (shown in FIG. 1) based on consumption parameters associated with the vehicles 104. The scheduling system 110 includes an energy module 204 that determines the consumption parameters for the vehicles 104 (shown in FIG. 1). In one embodiment, the scheduling module 202 may create a candidate schedule for one or more of the vehicles 104, where the candidate schedule includes a candidate movement event. The energy module 204 may calculate one or more consumption parameters of the vehicles 104 that are scheduled to participate in the candidate movement event. For example, the energy module 204 may refer to the memory 200 to obtain information about the candidate movement event (e.g., a location of the movement event, the grade and/or type of route 102 involved in the movement event, a time of the movement event, and the like), information about the vehicle 104 or vehicles 104 that are scheduled to participate in the candidate movement event (e.g., size and/or weights of the vehicles 104, types of propulsion subsystems 118 of the vehicles 104, tractive efforts provided by the vehicles 104, and the like), and/or other information. Based on this information, the energy module. 204 may calculate the consumption parameters for the vehicles 104 participating in the candidate movement events.

As described below, the energy module 204 may calculate how much kinetic energy would be lost or is likely to be (e.g., more likely than not) lost by a vehicle 104 (shown in FIG. 1) slowing down and/or stopping for a movement event, how much kinetic energy would be or is likely to be regained by the vehicle 104 during subsequent acceleration, and/or how much extra fuel would be or is likely to be consumed by the vehicle 104 when the vehicle 104 slows down and/or stops and then accelerates versus not slowing down and/or stopping and then accelerating. The consumption parameter may represent this projected lost kinetic energy, regained kinetic energy, and/or extra fuel consumed by one or more of the vehicles 104.

The consumption parameters can be reported back to the scheduling module 202 by the energy module 204. The scheduling module 202 receives the consumption parameters from the energy module 202 and generates and/or modifies the schedules that are transmitted to the vehicles 104 (shown in FIG. 1) based on the consumption parameters. For example, the scheduling module 202 may include a candidate movement event in a schedule that is transmitted to a vehicle 104 based on the consumption parameters. Alternatively, the scheduling module 202 may change a previously formed schedule based on the consumption parameters and send the modified schedule (or the modification to the schedule) to one or more of the vehicles 104.

In one embodiment, the scheduling module 202 determines which of plural vehicles 104 (shown in FIG. 1) will slow down and/or stop at a movement event involving the plural vehicles 104 based on a comparison of the consumption parameters. For example, the scheduling module 202 may compare a first consumption parameter of a first vehicle 104 with a second consumption parameter of a second vehicle 104 and, based on the comparison, select one of the first and second vehicles 104 to slow down and/or stop for a meet event or pass event between the first and second vehicles 104. The scheduling module 202 can select the vehicle 104 having the lower consumption parameter as the vehicle 104 that slows down and/or stops and/or select the vehicle 104 having the greater consumption parameter as the vehicle 104 that passes the other vehicle 104 and does not slow down and/or stop. Based on this comparison, the scheduling module 202 may create and/or modify the candidate movement event accordingly and include the candidate movement event in the schedules that are sent to the first and second vehicles 104.

In another embodiment, the energy module 204 may assign movement priorities to the vehicles 104 (shown in FIG. 1) based on the consumption parameters. The movement priorities may be assigned to indicate relative priorities between different vehicles 104 in deciding which vehicles 104 will slow down and/or stop during a movement event. For example, the energy module 204 may assign higher movement priorities to the vehicles 104 having larger consumption parameters for one or more movement events and lower movement priorities to the vehicles 104 having lower consumption parameters. The scheduling module 202 may compare the movement priorities for the vehicles 104 associated with a candidate movement event and schedule the vehicle 104 having the lower movement priority to slow down and/or stop for the movement event.

Alternatively, the energy module 204 may calculate the consumption parameters and/or movement priorities for the vehicles 104 (shown in FIG. 1) before the scheduling module 202 generates the candidate schedules and/or candidate movement events. For example, the energy module 204 may calculate the consumption parameters based on information about the vehicles 104 (e.g., how much kinetic energy is lost when the vehicle 104 slows down and/or stops, how much fuel is consumed by the vehicle 104 accelerating after slowing down and/or stopping, and the like). The energy module 204 can report the consumption parameters and/or movement priorities to the scheduling module 202. Additionally or alternatively, the energy module 204 can store the consumption parameters and/or movement priorities in the memory 200 for later access by the scheduling module 202. The scheduling module 202 may then refer to the consumption parameters and/or movement priorities when creating schedules for the vehicles 104.

An output module 206 of the scheduling system 110 controls communication between the scheduling system 110 and one or more of the vehicles 104 and/or the control devices 130 (shown in FIG. 1). For example, the output module 206 may be operatively coupled with the antenna 112 to permit the scheduling module 206 to control transmission of data (e.g., schedules, modifications to schedules, consumption parameters, and the like) to the vehicles 104 and/or the control devices 130. The output module 206 also may receive data (e.g., locations, speeds, masses, sizes, and/or weights of the vehicles 104 and/or statuses of the wayside devices 132 shown in FIG. 1) from the vehicles 104 and/or control devices 130.

FIG. 3 is a schematic diagram of one embodiment of a vehicle 104. While the vehicle 104 is illustrated as a powered rail vehicle (e.g., a locomotive), alternatively, the vehicle 104 may be another type of vehicle, such as another type of off-highway vehicle (e.g., a marine vessel or mining dump truck), an automobile, an airplane, and the like. As described above, the vehicle 104 includes the control system 114 that is communicatively coupled with the antenna 116.

The control system 114 includes a communication module 300 that is communicatively coupled with the antenna 116 for receiving the schedules and/or modifications to the schedules that are sent by the scheduling system 110 (shown in FIG. 1). Alternatively, the control system 114 may receive the schedules and/or modifications to the schedules from another source, such as an input device 302 of the vehicle 104. The input device 302 may include a keyboard, microphone, touchscreen, electronic mouse, joystick, or other device, that receives information such as the schedules and/or modifications to the schedules.

A control device 304 of the control system 114 receives the schedules and/or modifications to the schedules and generates output signals that are used to control the vehicle 104 based on the schedules and/or modifications to the schedules. The control device 304 is communicatively coupled with the propulsion subsystem 118 of the vehicle 104. The propulsion subsystem 118 can include one or more motive assemblies 306) that generate tractive effort to propel the vehicle 104 (such as an engine, alternator, generator, traction motor, and the like). The propulsion subsystem 118 also may include one or more braking assemblies 308, such as one or more air brakes, dynamic brakes, and the like, that generate braking effort to slow down and/or stop movement of the vehicle 104. The control device 304 may generate the output signals and communicate the output signals to the propulsion subsystem 118 to automatically control the movement of the vehicle 104, such as by automatically changing throttle settings of the motive assembly 306 and/or brake settings of the braking assembly 308. Alternatively, the control device 304 may communicate the output signals to an output device 310, such as an electronic display, monitor, speaker, tactile device, or other device, that visually, audibly, and/or tactually notifies an operator of how to change or control the movement of the vehicle 104. For example, the output device 310 may instruct the operator of the throttle settings and/or brake settings to be used for the vehicle 104.

In one embodiment, the control system 114 receives the schedule sent from the scheduling system 110 (shown in FIG. 1) and generates a trip plan based on the schedule. The trip plan may include throttle settings, brake settings, designated speeds, or the like, of the vehicle 104 for various sections of a scheduled trip of the vehicle 104 to the scheduled destination location. The trip plan may be generated to reduce the amount of fuel that is consumed and/or emissions that are generated by the vehicle 104 as the vehicle 104 travels to the destination location relative to travel by the vehicle 104 to the destination location when not abiding by the trip plan.

In order to generate the trip plan for the vehicle 104, the control device 304 can refer to a trip profile that includes information related to the vehicle 104, information related to the route 102 (shown in FIG. 1) over which the vehicle 104 travels to arrive at the scheduled destination, and/or other information related to travel of the vehicle 104 to the scheduled destination location at the scheduled arrival time. The information related to the vehicle 104 may include information regarding the fuel efficiency of the vehicle 104 (e.g., how much fuel is consumed by the vehicle 104 to traverse different sections of a route 102), the tractive power (e.g., horsepower) of the vehicle 104, the weight or mass of the vehicle 104 and/or cargo, the length and/or other size of the vehicle 104, the location of the powered units 106 (shown in FIG. 1) in the vehicle 104 (e.g., front, middle, back, or the like of a vehicle consist having several mechanically interconnected units 106, 108 shown in FIG. 1), or other information. The information related to the route 102 to be traversed by the vehicle 104 can include the shape (e.g., curvature), incline, decline, and the like, of various sections of the route 102, the existence and/or location of known slow orders or damaged sections of the route 102, and the like. Other information can include information that impacts the fuel efficiency of the vehicle 104, such as atmospheric pressure, temperature, and the like.

The trip plan is formulated by the control device 304 based on the trip profile. For example, if the trip profile requires the vehicle 104 to traverse a steep incline and the trip profile indicates that the vehicle 104 is carrying significantly heavy cargo, then the control device 304 may form a trip plan that includes or dictates increased tractive efforts to be provided by the propulsion subsystem 118 of the vehicle 104. Conversely, if the vehicle 104 is carrying a smaller cargo load and/or is to travel down a decline in the route 102 (shown in FIG. 1) based on the trip profile, then the control device 304 may form a trip plan that includes or dictates decreased tractive efforts by the propulsion subsystem 118 for that segment of the trip. In one embodiment, the control device 304 includes a software application or system such as the Trip Optimizer™ system provided by General Electric Company.

The control device 304 can generate the output signals for automatically controlling the propulsion subsystem 118 and/or for directing the operator to control the propulsion subsystem 118 based on the trip profile. For example, the control device 304 may generate output signals that direct the throttle settings and/or brake settings to be used so that the speed of the vehicle 104 matches the speeds of the vehicle 104 dictated by the trip plan.

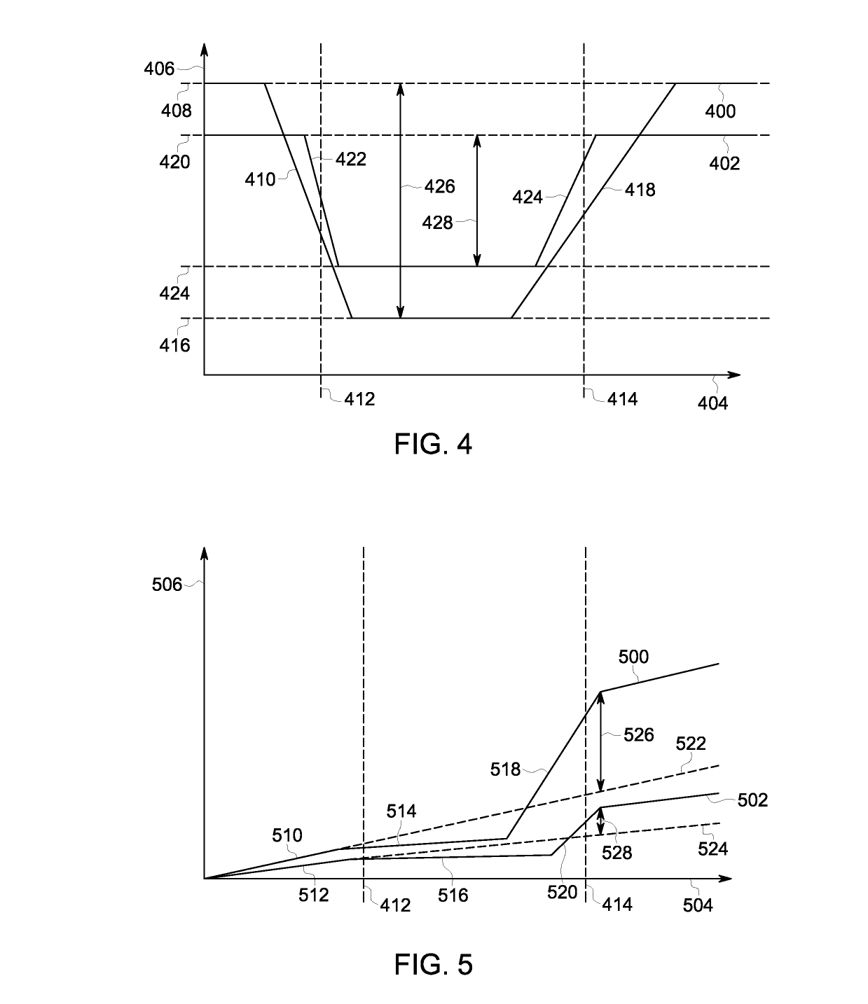

FIG. 4 is an illustration of projected energy profiles 400, 402 for two different vehicles 104 (shown in FIG. 1) during a movement event in accordance with one example. The energy profiles 400, 402 are shown along a horizontal axis 404 that represents distance and a vertical axis 406 that represents kinetic energy of the vehicles 104. In one example, the energy profiles 400, 402 may represent the projected kinetic energies of first and second vehicles 104, respectively, as the first and second vehicles 104 participate in a meet event or a pass event. For example, the energy profile 400 may represent the projected kinetic energy of a larger and/or heavier vehicle 104 that pulls off a route 102 (shown in FIG. 1) onto a siding section route 124 (shown in FIG. 1) to allow another vehicle 104 to pass. The energy profile 402 may represent the projected kinetic energy of a smaller and/or lighter vehicle 104 that pulls off onto the siding section route 124 from the route 102 to allow another vehicle 104 to pass.

The illustrated energy profiles 400, 402 represent the projected kinetic energies of the vehicles 104 for a pass event where the vehicles 104 travel in a common direction. Alternatively, the energy profiles 400, 402 may represent the projected kinetic energies of the vehicles 104 for a meet event where the vehicles 104 travel in opposite directions, with the energy profile 402 reversed such that the horizontal axis 404 extends in an opposite direction for the lighter vehicle 104 relative to what is shown in FIG. 4.

In creating the schedules of the heavier and lighter vehicles 104 (shown in FIG. 1), the scheduling system 110 (shown in FIG. 1) may consider energy losses associated with the vehicles 104 in order to determine which of the vehicles 104 should pull off of the route 102 (shown in FIG. 1) and onto a siding section route 124 (shown in FIG. 1) during a movement event such as a meet event or pass event.

As shown in FIG. 4, the heavier vehicle 104 (shown in FIG. 1) has or is projected to have an initial kinetic energy 408 when traveling along the route 102 (shown in FIG. 1). When the heavier vehicle 104 starts to slow down to pull onto the siding section route 124 (shown in FIG. 1), the kinetic energy decreases (e.g., is projected, calculated, or estimated to decrease), as shown by a decreasing segment 410 of the energy curve 400. The siding section route 124 may be considered to extend from a first location 412 along the horizontal axis 404 to a second location 414 along the horizontal axis 404. For example, the first location 412 may represent an intersection between the route 102 and the siding section route 124 that is closer to the approaching vehicle 104 (and where the vehicle 104 pulls onto the siding section route 124). The second location 414 may represent an intersection between the route 102 and the siding section route 124 that is farther from the approaching vehicle 104, such as the location where the vehicle 104 pulls back onto the route 102 from the siding section route 124.

The kinetic energy of the heavier vehicle 104 (shown in FIG. 1) is projected to decrease to a lower kinetic energy 416 while the heavier vehicle 104 slows down on the siding section route 124 (shown in FIG. 1). If the heavier vehicle 104 stops on the siding section route 124, then the lower kinetic energy 416 may be projected to coincide with the horizontal axis 404. The kinetic energy of the heavier vehicle 104 then is calculated or estimated to increase along an increasing segment 418 as the heavier vehicle 104 accelerates to return onto the route 102 (shown in FIG. 1) and travel at a designated speed, such as the speed limit of the route 102. In the illustrated example, the kinetic energy of the heavier vehicle 104 is projected to return to the initial kinetic energy 408.

With respect to the lighter vehicle 104 (shown in FIG. 1), the vehicle 104 may be projected to have a lower initial kinetic energy 420 when traveling along the route 102 (shown in FIG. 1). When the lighter vehicle 104 starts to slow down to pull onto the siding section route 124 (shown in FIG. 1), the kinetic energy is projected to decrease, as shown by a decreasing segment 422 of the energy curve 402. The kinetic energy of the lighter vehicle 104 is projected to decrease to a lower kinetic energy 424 while the vehicle 104 slows down on the siding section route 124. If the lighter vehicle 104 stops on the siding section route 124, then the lower kinetic energy 424 may coincide with the horizontal axis 404. The kinetic energy of the lighter vehicle 104 then is calculated or expected to increase along an increasing segment 426 as the lighter vehicle 104 accelerates to return onto the route 102 and travel at a designated speed, such as the speed limit of the route 102. In the illustrated example, the kinetic energy of the lighter vehicle 104 is projected to return to the initial kinetic energy 420.

When creating and/or modifying schedules of the vehicles 104 (shown in FIG. 1), the energy module 204 (shown in FIG. 2) of the scheduling module 110 (shown in FIG. 1) may calculate a potential decrease in kinetic energy in the heaver vehicle 104 during an upcoming or forthcoming movement event relative to a potential decrease in kinetic energy in the lighter vehicle 104 during the movement event. For example, the energy module 204 may calculate or estimate an energy loss 426 associated with the heaver vehicle 104 and an energy loss 428 associated with the lighter vehicle 104. The energy losses 426, 428 may represent the differences in projected kinetic energy of the vehicles 104 between the vehicles 104 traveling along the route 102 (shown in FIG. 1) and slowing and/or stopping on the siding section route 124 (shown in FIG. 1).

FIG. 5 is an illustration of fuel consumption profiles 500, 502 for two different vehicles 104 (shown in FIG. 1) during the movement event represented in FIG. 4. The consumption profiles 500, 502 are shown along a horizontal axis 504 that represents distance and a vertical axis 506 that represents an amount of fuel consumed by the vehicles 104. The consumption profiles 500, 502 may represent projected cumulative amounts of fuel consumed over time as the vehicles 104 travel. In one example, the consumption profiles 500, 502 may represent the projected amounts of fuel consumed by the first and second vehicles 104, respectively, as the first and second vehicles 104 participate in a meet event or a pass event. For example, the consumption profile 500 may represent the projected amount of fuel consumed by a larger and/or heavier vehicle 104 during a meet event or pass event and the consumption profile 502 may represent the projected amount of fuel consumed by a smaller and/or lighter vehicle 104 during the meet event or pass event.

As shown in FIG. 5, the amounts of fuel consumed by the vehicles 104 (shown in FIG. 1) are projected to increase at relatively steady rates during increasing segments 510, 512, respectively, as the vehicles 104 approach the siding section route 124 (shown in FIG. 1). The rates at which the vehicles 104 consume fuel then are projected to decrease slightly during slowing segments 514, 516 of the profiles 500, 502 as the vehicles 104 slow down and/or stop during the movement event. The rates at which the vehicles 104 consume fuel then are projected to increase significantly as the vehicles 104 accelerate to pull back onto the route 102 (shown in FIG. 1), as shown in increasing segments 518, 520 of the profiles 500, 502. The profiles 500, 502 are projected to continue to increase as the vehicles 104 continue to travel along the route 102.

Alternate profiles 522, 524 are shown for the heavier and lighter vehicles 104 (shown in FIG. 1), respectively. The alternate profiles 522, 524 represent the projected amounts of fuel consumed for each of the vehicles 104 if the respective vehicle 104 continues along the route 102 (shown in FIG. 1) and does not slow down or stop on the siding section route 124 (shown in FIG. 1). The projected amounts of fuel consumed by the vehicles 104 may continue to increase at a relatively steady rate if the vehicles 104 do not slow down and/or stop, and/or do not accelerate after slowing down and/or stopping.

The energy module 204 (shown in FIG. 2) of the scheduling module 110 (shown in FIG. 1) may calculate increases in the amounts of fuel that may be consumed by each of the vehicles 104 if the vehicles 104 slow down and/or stop during the upcoming movement event or do not slow down and/or stop during the upcoming movement event. For example, the energy module 202 may calculate or estimate an extra fuel consumed parameter 526 for the heaver vehicle 104 and an extra fuel consumed parameter 528 for the lighter vehicle 104 that represent the projected amounts of extra fuel that may be consumed by each vehicle 104 if the vehicles 104 stop and/or slow down during the upcoming movement event rather than continue along the route 102 and not slow down and/or stop on the siding section route 124.

As shown in FIG. 5, the extra fuel consumed parameter 526 of the heavier vehicle 104 (shown in FIG. 1) is greater than the extra fuel consumed parameter 528 of the lighter vehicle 104. The larger extra fuel consumed parameter 526 may indicate that the heavier vehicle 104 will or is likely to consume more fuel than the lighter vehicle 104 in slowing down and/or stopping during the upcoming movement event, followed by accelerating back onto the route 102.

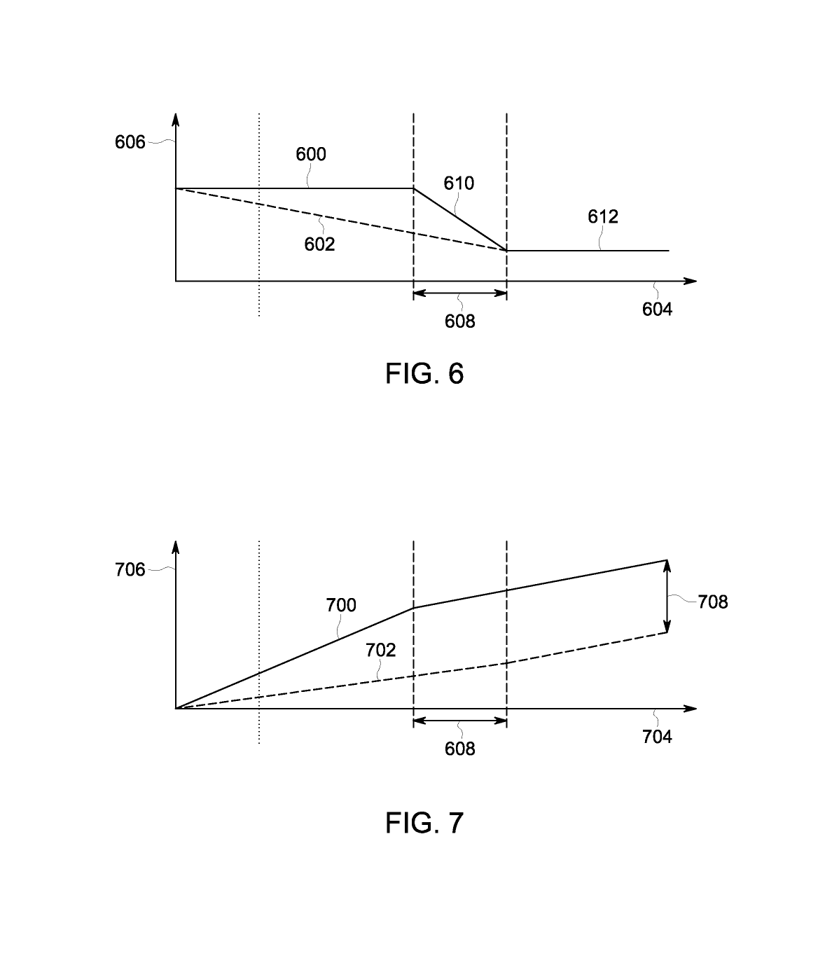

FIG. 6 is an illustration of speed profiles 600, 602 for a vehicle 104 (shown in FIG. 1) during a movement event in accordance with another example. FIG. 7 is an illustration of fuel consumption profiles 700, 702 associated with the speed profiles 600, 602 shown in FIG. 6. The speed profiles 600, 602 are shown alongside a horizontal axis 604 representative of distance and a vertical axis 606 representative of speeds of the vehicle 104. The fuel consumption profiles 700, 702 are shown alongside a horizontal axis 704 representative of distance and a vertical axis 706 representative of cumulative amounts of fuel consumed by the vehicle 104. The fuel consumption profiles 700, 702 represent the projected cumulative amounts of fuel consumed by the vehicles 104 that are associated with the speed profiles 600, 602.

The speed profile 600 and the fuel consumption profile 700 represent the projected speeds and amounts of fuel consumed when a vehicle 104 (shown in FIG. 1) traveling along a route 102 (shown in FIG. 1) abruptly slows down over a distance 608. The vehicle 104 may slow down because the vehicle 104 is a trailing vehicle 104 that is approaching a leading vehicle 104 traveling on the route 102 in the same direction. For example, a trailing vehicle 104 that is following a leading vehicle 104 on the same route 102 may be prohibited from coming within a designated safety distance from that the second vehicle 104. As shown in FIGS. 6 and 7, the trailing vehicle 104 may be traveling at an approximately constant speed and be consuming an approximately constant rate of fuel as the trailing vehicle 104 approaches the leading vehicle 104. If the trailing vehicle 104 comes too close or is about to come too close to the leading vehicle 104, then the trailing vehicle 104 may abruptly slow down over the distance 608, as shown by a decreasing segment 610 in the speed profile 600, to a slower speed 612.

Alternatively, the trailing vehicle 104 (shown in FIG. 1) may slow down before the trailing vehicle 104 comes too close to the leading vehicle 104, as shown by the speed profile 602 (with the associated amounts of fuel consumed represented by the fuel consumption profile 702). For example, the trailing vehicle 104 may slow down at an earlier time when the trailing vehicle 104 is farther from the leading vehicle 104. As shown in FIGS. 6 and 7, slowing down at an earlier time may allow the trailing vehicle 104 to slow down more gradually and consume less fuel over a longer period of time. As a result, the amount of fuel consumed by the trailing vehicle 104 may be less than if the trailing vehicle 104 has to abruptly slow down. The difference between the amounts of fuel that may be consumed can be referred to as an extra fuel consumed parameter 708.

In another example, the profiles 600, 602 and the profiles 700, 702 may apply to another type of movement event, such as a convergence event or divergence event. For example, in a convergence event, the profiles 600, 602 and the profiles 700, 702 may represent the alternate projected speeds and amounts of fuel consumed for a vehicle 104 (shown in FIG. 1) that will trail another vehicle 104 following the upcoming convergence event. If the vehicle 104 approaches the convergence event too quickly (e.g., according to the profiles 600, 700), then the trailing vehicle 104 may be forced to abruptly slow down for the other vehicle 104 to pull onto the converged route 102 ahead of the trailing vehicle 104. On the other hand, if the trailing vehicle 104 approaches the convergence event more slowly (e.g., according to the profiles 602, 702), then the trailing vehicle 104 may not be forced to abruptly slow down and may consume less fuel during the convergence event.

In a divergence event, the profiles 600, 602 and the profiles 700, 702 may represent the alternate projected speeds and amounts of fuel consumed for a vehicle 104 (shown in FIG. 1) that is trailing a leading vehicle 104 toward the divergence event. If the trailing vehicle 104 approaches the divergence event too quickly (e.g., according to the profiles 600, 700), then the trailing vehicle 104 may be forced to abruptly slow down to avoid approaching too closely to the leading vehicle 104 before the divergence event. On the other hand, if the trailing vehicle 104 approaches the divergence event more slowly (e.g., according to the profiles 602, 702), then the trailing vehicle 104 may not come too close to the leading vehicle 104 and may not be forced to abruptly slow down and may consume less fuel during the divergence event.

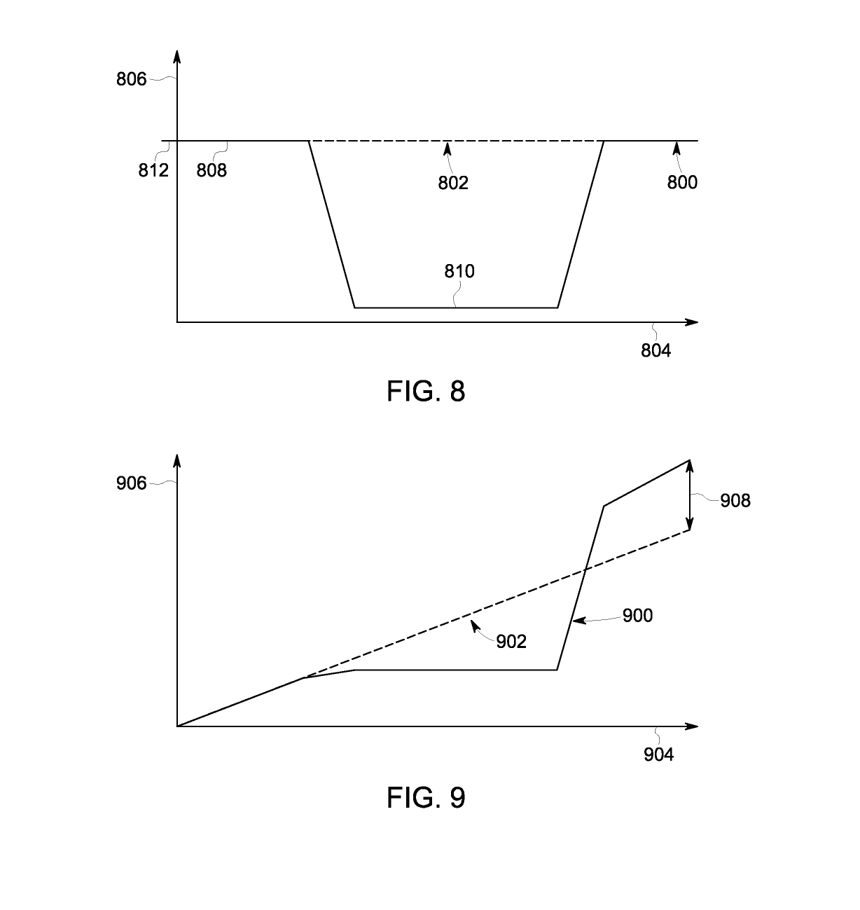

FIG. 8 is an illustration of energy profiles 800, 802 for a vehicle 104 (shown in FIG. 1) during a movement event in accordance with another example. FIG. 9 is an illustration of fuel consumption profiles 900, 902 associated with the energy profiles 800, 802 shown in FIG. 8. The energy profiles 800, 802 are shown alongside a horizontal axis 804 representative of distance and a vertical axis 806 representative of kinetic energy of the vehicle 104. The fuel consumption profiles 900, 902 are shown alongside a horizontal axis 904 representative of distance and a vertical axis 906 representative of projected cumulative amounts of fuel consumed by the vehicle 104.

The energy profile 800 and the fuel consumption profile 900 represent the projected kinetic energy and amounts of fuel consumed when a vehicle 104 (shown in FIG. 1) traveling along a route 102 (shown in FIG. 1) slows down and/or stops for a movement event, such as to wait for a bridge 122 (shown in FIG. 1) to lower before the vehicle 104 can pass over the bridge 122. Alternatively, the energy profile 800 and the fuel consumption profile 900 may represent the kinetic energy and amounts of fuel consumed when the vehicle 104 slows down to travel through a slow region 120 (shown in FIG. 1) of the transportation network 100 (shown in FIG. 1).

For example, the vehicle 104 (shown in FIG. 1) may travel at an initial speed 808 (e.g., a speed limit of the route 102 shown in FIG. 1) until the vehicle 104 approaches the raised bridge 122 (shown in FIG. 1) and/or the slow region 120 (shown in FIG. 1). The vehicle 104 may then decrease speed to a reduced speed 810, which can represent slow movement of the vehicle 104 through the slow region 120 or stoppage of the vehicle 104 before reaching the raised bridge 122. When the bridge 122 is lowered or the vehicle 104 has exited the slow region 120, the vehicle 104 may accelerate back to the speed 808, as shown in FIG. 8. As stated above, the fuel consumption profile 900 may represent the cumulative amount of fuel consumed by the vehicle 104 as the vehicle 104 travels according to the speed profile 800.

Alternatively, the raising of the bridge 122 (shown in FIG. 1) may be delayed or the start of the lower speed limit for the slow region 120 (shown in FIG. 1) may be delayed. For example, raising the bridge 122 may be delayed until the vehicle 104 (shown in FIG. 1) passes over the lowered bridge 122. As another example, the start of maintenance on the route 102 and/or another start of a reduced speed limit for the slow region 120 may be delayed until the vehicle 104 passes the area where the maintenance will occur or where the slow region 120 will occur. In another example, a switch may be activated to cause the vehicle 104 to travel around the slow region 120 and/or the raised bridge 122 to avoid having the vehicle 104 slow down and/or stop. For example, the vehicle 104 may bypass the slow region 120.

The speed profile 802 and the fuel consumption profile 902 can represent the speed of the vehicle 104 (shown in FIG. 1) and the amounts of fuel consumed by the vehicle 104 when the vehicle 104 avoids the movement event, such as by delaying the raising of the bridge 122 (shown in FIG. 1), delaying the initiation of the slow region 120 (shown in FIG. 1), and/or traveling around the slow region 120 and/or bridge 122. As shown in the speed profile 802 of FIG. 8, the vehicle 104 may travel at a designated speed 812, such as a speed limit of the route 102 (shown in FIG. 1), over the bridge 122 before the bridge 122 is raised and/or through the area of the route 102 where the slow region 120 will occur at a later time. As shown in the accompanying fuel consumption profile 902 shown in FIG. 9, by traveling at the speed 812 according to the speed profile 802 instead of slowing down to wait for the bridge 122 to be lowered and/or to travel through the slow region 120 before accelerating again, the vehicle 104 may consume less fuel. A fuel consumption difference 908 may represent the difference in fuel that is consumed by the vehicle 104 not slowing down and/or stopping, and then accelerating versus the vehicle 104 slowing down and/or stopping, and then accelerating.

Returning to the discussion of the scheduling module 110 that is shown in FIG. 2, in one embodiment, the energy module 204 may determine consumption parameters based on the kinetic energy losses and/or extra amounts of fuel consumed by the vehicles 104 (shown in FIG. 1). With respect to the examples shown in FIGS. 4 through 9, the consumption parameter may be equal to, based on, and/or representative of the energy loss 426 (shown in FIG. 4) for the heavier vehicle 104, the energy loss 428 (shown in FIG. 4) for the lighter vehicle 104, the extra fuel consumed parameter 526 (shown in FIG. 5) for the heavier vehicle 104, the extra fuel consumed parameter 528 (shown in FIG. 5) of the lighter vehicle 104, the extra fuel consumed parameter 708 (shown in FIG. 7), the extra fuel consumed parameter 908 (shown in FIG. 9), and the like.

As one example, if a vehicle 104 (shown in FIG. 1) includes a train weighing in excess of 10,000 tons (e.g., a mass of 9.07×10⁶ kilograms) that may travel on a route 102 (shown in FIG. 1) at a speed of 50 miles per hour (e.g., 22.4 meters per second), the energy module 204 may calculate the kinetic energy loss of the vehicle 104 when the vehicle 104 stops during a movement event as follows:

$$K E = \frac{1}{2} m \cdot {V}^{2} \qquad ( Eqn . 1 a )$$

where KE represents the kinetic energy of the vehicle 104, m represents the mass of the vehicle 104 (e.g., 9.07×10⁶ kilograms), and V represents the speed of the vehicle 104 before slowing down (e.g., 2.24 meters per second). With the above example, the energy module 204 may calculate a kinetic energy loss of 2.3×10⁹ Joules, that is, the vehicle would lose this amount of energy if the vehicle was traveling 50 miles per hour and then came to a stop. As described above, the consumption parameter of the vehicle 104 may represent or include such a value of the kinetic energy loss. For calculating an energy loss for slowing:

$$K E = \frac{1}{2} m \cdot ( {V}_{1}^{2} - {V}_{2}^{2} ) \qquad ( Eqn . 1 b )$$

where V₁ is an initial velocity and V₂ is a second velocity subsequent slowing.

Alternatively, the consumption parameter of the vehicle 104 (shown in FIG. 1) may represent the extra fuel consumed by the vehicle 104, as described above. The energy module 204 may calculate the extra fuel consumed by the vehicle 104 as follows:

F=d·KE (Eqn. 2)

where F represents the extra fuel consumed by the vehicle 104 accelerating after slowing down and/or stopping, d represents the energy density of the fuel consumed by the vehicle 104, and KE represents the kinetic energy loss described above. In continuing with the above example, the energy module 204 may determine that the vehicle 104 will consume 68 liters of fuel to accelerate after slowing down and/or stopping. The consumption parameter of the vehicle 104 may represent or include such a value of extra fuel consumed.

In one embodiment, the consumption parameter of a vehicle 104 (shown in FIG. 1) may represent a cost and/or availability of the fuel that is consumed by the vehicle 104. For example, if the vehicle 104 uses a relatively expensive fuel and/or a fuel that is available at relatively fewer locations in the transportation network 100 for refueling, the consumption parameter of the vehicle 104 may be increased. Conversely, if the vehicle 104 uses a less expensive fuel and/or a fuel that is available at a greater number of locations, the consumption parameter of the vehicle 104 may be decreased. The consumption parameter may be changed based on the fuel costs and/or availability in order to weigh additional factors in the calculation of the amount of fuel consumed by the vehicle 104 during a movement event. For example, if a first vehicle 104 uses a more expensive fuel than a second vehicle 104 and the first and second vehicles 104 consume the same amount of fuel during slowing and/or stopping during a movement event, the consumption parameter (and/or movement priority) of the first vehicle 104 may be greater than the second vehicle 104 so that the first vehicle 104 is preferred (e.g., given priority) over the second vehicle 104 when scheduling movement events. The first vehicle 104 may be preferred in order to reduce the financial costs and/or feasibility of refueling the first vehicle 104 that are associated with travel of the first vehicle 104.

As described above, the scheduling module 202 refers to the consumption parameters and/or movement priorities that are based on the consumption parameters to create and/or modify the schedules of the vehicles 104 (shown in FIG. 1). For example, the scheduling module 202 can compare the consumption parameters and/or movement priorities to determine which vehicle 104 in a meet event or pass event should slow down and/or stop based on which vehicle 104 has a lower consumption parameter and/or lower movement priority (e.g., the vehicle 104 with the lower consumption parameter or lower movement priority being the vehicle 104 that slows down and/or stops).

As another example, the scheduling module 202 can determine if the raising of a bridge 122 (shown in FIG. 1) and/or the start of a lower speed limit for a slow region 120 (shown in FIG. 1) should be delayed based on a consumption parameter and/or movement priority of a vehicle 104. In one embodiment, if the consumption parameter and/or movement priority of the vehicle 104 is sufficiently large (e.g., exceeds one or more designated thresholds), then the scheduling module 202 may delay the raising of the bridge 122 and/or start of the slower speed limit in a schedule of the bridge 122 and/or slow region 120 until after the vehicle 104 has passed over the bridge 122 and/or through the slow region 120. Alternatively, the scheduling module 202 may schedule the vehicle 104 so that the vehicle 104 crosses the bridge 122 and/or passes through the slow region 120 before the bridge 122 is raised and/or the slow region 120 begins.

In addition to or as an alternate to creating and/or modifying schedules of the vehicles 104 (shown in FIG. 1) based on the consumption parameters and/or movement priorities, the movement of the vehicles 104 can be controlled based on the consumption parameters and/or movement priorities. By “real-time,” it is meant that the consumption parameters and/or movement priorities may be used to control movement of the vehicles 104 as the vehicles 104 are moving in the transportation network 100 (shown in FIG. 1). For example, throttle settings and/or brake settings may be automatically and/or manually changed based on the consumption parameters and/or movement priorities as the vehicles 104 are moving.

In one embodiment, the scheduling system 110 (shown in FIG. 1) may transmit output signals to one or more vehicles 104 (shown in FIG. 1) to change previously transmitted schedules of the vehicles 104 to change the schedules based on the consumption parameters and/or movement priorities. For example, after a schedule is transmitted to a vehicle 104 and the vehicle 104 is moving in the transportation network 100 (shown in FIG. 1) according to the schedule, the scheduling system 110 can transmit a change in the schedule (e.g., a change in whether the vehicle 104 slows down and/or stops or passes in a movement event, a change in a path taken by the vehicle 104 to avoid a slow region 120, a change in when the vehicle 104 travels over the bridge 122, and the like) while the vehicle 104 is moving. The control system 114 (shown in FIG. 1) of the vehicle 104 can receive the change and automatically change the throttle settings and/or brake settings of the vehicle 104 and/or communicate the changes to the operator of the vehicle 104 based on the output signals, as described above.

In another embodiment, the scheduling system 110 (shown in FIG. 1) may communicate output signals to one or more of the control devices 130 (shown in FIG. 1) to cause the control devices 130 to control the wayside devices 132 (shown in FIG. 1) while the vehicles 104 (shown in FIG. 1) are traveling and based on the consumption parameters and/or movement priorities.

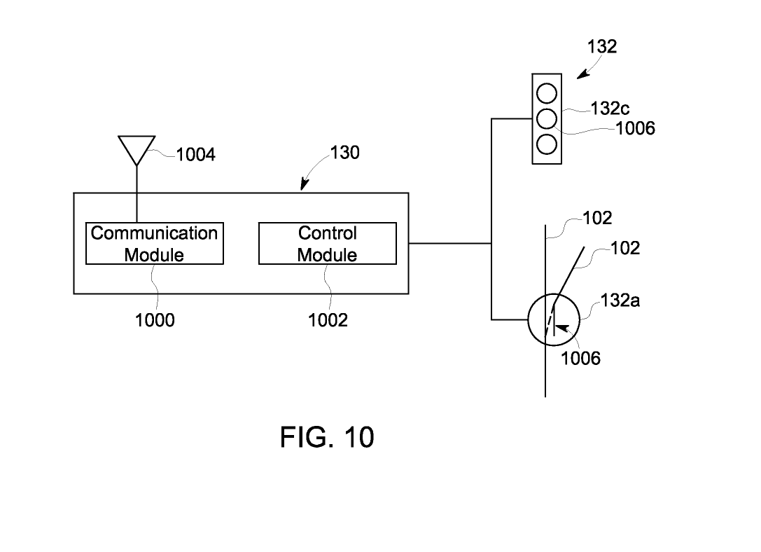

FIG. 10 is a schematic diagram of one embodiment of a control device 130 and wayside devices 132. The control device 130 includes a communication unit 1000 and a control module 1002. The communication unit 1000 controls communication between the control device 130 and other devices, such as the scheduling system 110 (shown in FIG. 1) and/or the wayside devices 132 (e.g., the wayside devices 132a, 132c). For example, the communication unit 1000 may be communicatively coupled with an antenna 1004, such as a cellular or RF antenna, of the control device 130 to wirelessly communicate with the scheduling system 110 and/or the wayside devices 132. The communication unit 1000 may receive output signals from the scheduling system 110 that directs the control device 130 to actuate one or more wayside devices 132.

The control module 1002 of the control device 130 receives the output signals from the communication unit 1000 and determines how to control one or more of the wayside devices 132 based on the output signal. In the illustrated embodiment, the control device 130 is communicatively coupled with a signaling device as the wayside device 132c and a switch as the wayside device 132a. Alternatively, the control device 130 may be coupled with only a single wayside device 132 and/or may be coupled with different wayside device(s) 132.

As described above, some vehicles 104 (shown in FIG. 1) may reduce the amounts of fuel consumed during travel by slowing down in advance of approaching another vehicle 104 and/or a movement event. For example, a trailing vehicle 104 that is approaching a leading vehicle 104 traveling in the same direction on the same route 102 may consume less fuel by gradually slowing down before the trailing vehicle 104 is required to abruptly slow down if the trailing vehicle 104 gets too close to the leading vehicle 104 (e.g., as shown in FIGS. 6 and 7). In one embodiment, the scheduling system 116 may transmit an output signal to the control device 130 based on the consumption parameter and/or movement priority of a vehicle 104 approaching the wayside device 132c. For example, the scheduling system 110 may track positions of the vehicle 104 in the transportation network 100 (e.g., by the vehicle 104 periodically reporting geographic coordinates from a Global Positioning System on the vehicle 104 and/or wayside devices 132 reporting passage of the vehicle 104 past the wayside devices 132 to the scheduling system 110). When the vehicle 104 approaches the signal wayside device 132c, and if the consumption parameter and/or the movement priority of the vehicle 104 is sufficiently high (e.g., exceeds one or more thresholds), then the scheduling system 110 may direct the control device 130 to actuate the signal wayside device 132c. For example, the scheduling system 110 may transmit an output signal to the control device 130 that directs the control device 130 to actuate the signal wayside device 132c in such a manner that directs the operator of the trailing vehicle 104 to gradually slow down. In one embodiment, the control device 130 may cause a yellow (or other colored or non-colored) light 1006 of the wayside device 132c to be illuminated, which instructs the operator of the trailing vehicle 104 to slow down before approaching the leading vehicle 104 too closely. As another example, the control device 130 can control the wayside device 132c to cause a vehicle 104 to slow down so that the bridge 122 (shown in FIG. 1) is lowered before the vehicle 104 reaches the bridge 122, the reduced speed limit for a slow region 120 (shown in FIG. 1) is terminated, a meet event or pass event is avoided (e.g., by slowing down such that the other vehicle(s) 104 that would have been involved in the event have moved to other routes 102), and the like.

In another embodiment, the scheduling module 110 (shown in FIG. 1) transmits an output signal to the control device 130 that directs the control device 130 to actuate the switch wayside device 132a. For example, the switch wayside device 132a may be coupled to two or more routes 102 and capable of changing a position of a switch 1006. Changing the position of the switch 1006 can change which combination of routes 102 that a vehicle 104 (shown in FIG. 1) traveling past the switch 1006 moves along.

As described above, some vehicles 104 (shown in FIG. 1) may reduce the amounts of fuel consumed during travel by avoiding an area of the transportation network 100 (shown in FIG. 1) that may require slowing down and/or stopping. For example, a vehicle 104 with a sufficiently high consumption parameter and/or movement priority may reduce the amount of fuel consumed during a trip by traveling around, rather than through or over, a slow region 120, a movement event, a bridge 122 that is raised, and the like, as shown in the examples of FIGS. 8 and 9. The scheduling system 110 may transmit an output signal to the control device 130 based on the consumption parameter and/or movement priority of a vehicle 104 approaching the switch wayside device 132a. When the vehicle 104 approaches the switch wayside device 132a, and if the consumption parameter and/or the movement priority of the vehicle 104 is sufficiently high (e.g., exceeds one or more thresholds), then the scheduling system 110 may direct the control device 130 to actuate the switch wayside device 132a. Actuating the switch wayside device 132a may cause the vehicle 104 to take another route 102 that does not include the slow region 120, movement event, bridge 122, or other movement event.

In another embodiment, the wayside device 132 to which the control device 130 is communicatively coupled may be a system that controls the raising or lowering of the bridge 122 (shown in FIG. 1). For example, the wayside device 132 can include or be coupled with motors, gears, and/or other mechanisms to raise and/or lower the bridge 122. The scheduling system 110 (shown in FIG. 1) can communicate output signals to the control device 130 to cause the wayside device 132 to delay raising the bridge 122 until after a vehicle 104 has passed over the bridge 122 if the consumption parameter and/or movement priority of the vehicle 104 is sufficiently high. As another example, the scheduling system 110 can direct the control device 130 to cause the wayside device 132 to lower the bridge 122 for an approaching vehicle 104 if the consumption parameter and/or movement priority of the vehicle 104 is sufficiently high.

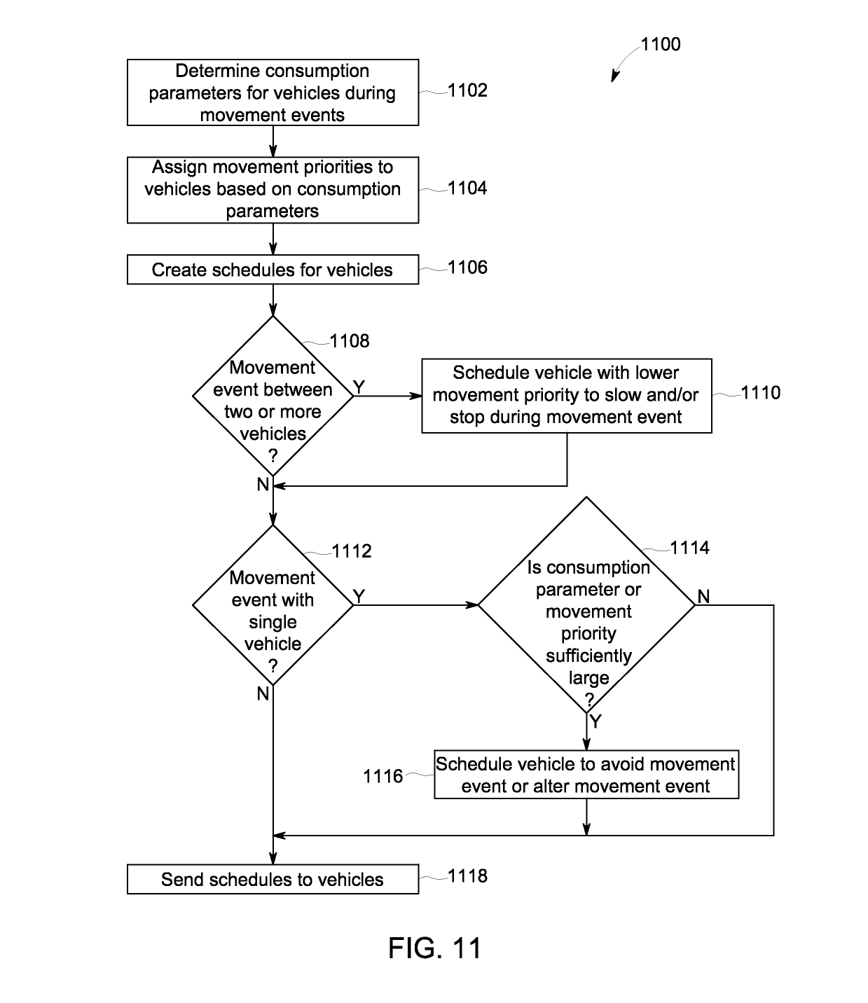

FIG. 11 is a flowchart of one embodiment of a method 1100 for scheduling movement of vehicles in a transportation network. The method 1100 may be used to create and/or modify the schedules of the vehicles 104 (shown in FIG. 1) based on the size and/or mass of the vehicles 104, the amounts of fuel consumed by the vehicles 104 during movement events, and/or the amounts of kinetic energy losses of the vehicles 104 during the movement events, as described herein. Reference is made to several components illustrated in the accompanying Figures without limiting the method 1100 to the illustrated embodiments.

At 1102, consumption parameters are determined for the vehicles 104 (shown in FIG. 1) during one or more movement events. For example, kinetic energy losses and/or amounts of fuel consumed by the vehicles 104 may be calculated for one or more events, such as a meet event, pass event, convergence event, divergence event, travel through a slow region 120 (shown in FIG. 1), travel across a bridge 122 (shown in FIG. 1), and the like. The consumption parameters of the vehicles 104 may be based on the energy losses and/or amounts of fuel. Alternatively, the consumption parameters may be based on the size (e.g., length, weight, and/or mass) of the vehicles 104, with larger vehicles 104 having larger consumption parameters. In another embodiment, the consumption parameter for one or more vehicles 104 may be at least partially based on the financial cost of the fuel used by the vehicles 104 and/or the availability of the fuel, as described above.

At 1104, movement priorities are assigned to the vehicles 104 (shown in FIG. 1) based on the consumption parameters. For example, vehicles 104 having larger consumption parameters may be assigned higher movement priorities. In one embodiment, the movement priorities can indicate which of the vehicles 104 should slow and/or stop for a movement event and which vehicles 104 should not slow and/or stop during the movement event in order to reduce the amount of fuel consumed by the vehicles 104. For example, vehicles 104 with larger consumption parameters may be scheduled to slow and/or stop less than vehicles 104 having smaller consumption parameters in order to reduce the fuel consumption of the vehicles 104.

At 1106, schedules for the vehicles 104 (shown in FIG. 1) are created. The schedules may be candidate schedules that are not yet transmitted to the vehicles 104 for use in traveling in the transportation network 100 (shown in FIG. 1).

At 1108, the schedule of one or more of the vehicles 104 (shown in FIG. 1) is examined to determine if the schedule includes a movement event involving plural vehicles 104. For example, the schedule may be examined to determine if the schedule includes a meet event or a pass event. If the schedule includes such a movement event, then the movement priorities of the plural vehicles 104 may need to be examined in order to ensure that the larger vehicle 104 does not slow and/or stop during the movement event. As a result, flow of the method 1100 may proceed to 1110. On the other hand, if the schedule does not include such a movement event, then flow of the method 1100 may proceed to 1112.

At 1110, the schedule of one or more of the vehicles 104 (shown in FIG. 1) involved in the movement event may be modified so that the vehicle 104 having the lower movement priority (and/or consumption parameter) is the vehicle 104 that is scheduled to slow and/or stop during the movement event. The schedule of another vehicle 104 having a higher movement priority (and/or greater consumption parameter) may be modified such that the vehicle 104 does not slow and/or stop during the movement event. In another embodiment, instead of first creating the schedules and then modifying the schedules of the vehicles 104, the schedules of the vehicles 104 may be created when the consumption parameters and/or movement priorities of the vehicles 104 are examined and/or compared to create the movement events in the schedules.

At 1112, the schedule of one or more of the vehicles 104 (shown in FIG. 1) is examined to determine if the schedule includes a movement event involving a single vehicle 104 (e.g., a singular event). For example, the schedule may be examined to determine if the schedule includes the vehicle 104 traveling over a bridge 122 (shown in FIG. 1) that can be raised, traveling through a slow region 120 (shown in FIG. 1), and the like. If the schedule includes such a movement event, then the consumption parameter and/or movement priority of the vehicle 104 may be examined in order to determine if fuel can be conserved by changing the movement event and/or schedule so that the vehicle 104 does not slow and/or stop. As a result, flow of the method 1100 may proceed to 1114. On the other hand, if the schedule does not include such a movement event, then flow of the method 1100 may proceed to 1118.

At 1114, the consumption parameter and/or movement priority of the vehicle 104 (shown in FIG. 1) that is scheduled to be involved in the singular event is examined. The consumption parameter and/or movement priority may be examined to determine if the consumption parameter and/or movement priority is sufficiently large that fuel can be conserved by changing or avoiding the movement event. If the consumption parameter and/or movement priority is sufficiently large (e.g., exceeds a designated threshold), then flow of the method 1100 may proceed to 1116. On the other hand, the flow of the method 1100 may proceed to 1118. For example, if the consumption parameter and/or the movement priority is too low, then the schedule may not be modified.

At 1116, the schedule of the vehicle 104 (shown in FIG. 1) is modified to avoid and/or alter the movement event. For example, the vehicle 104 may be scheduled to travel around the movement event. Alternatively, the movement event may be re-scheduled (e.g., delayed) to occur or start after the vehicle 104 has traveled past the location of the movement event.

At 1118, the schedules of the vehicles 104 (shown in FIG. 1) are communicated to the vehicles 104. For example, the schedules may be created and/or modified such that the larger vehicles 104 slow down and/or stop fewer times in order to conserve fuel that is consumed by the vehicles 104. The vehicles 104 may then travel according to the schedules.

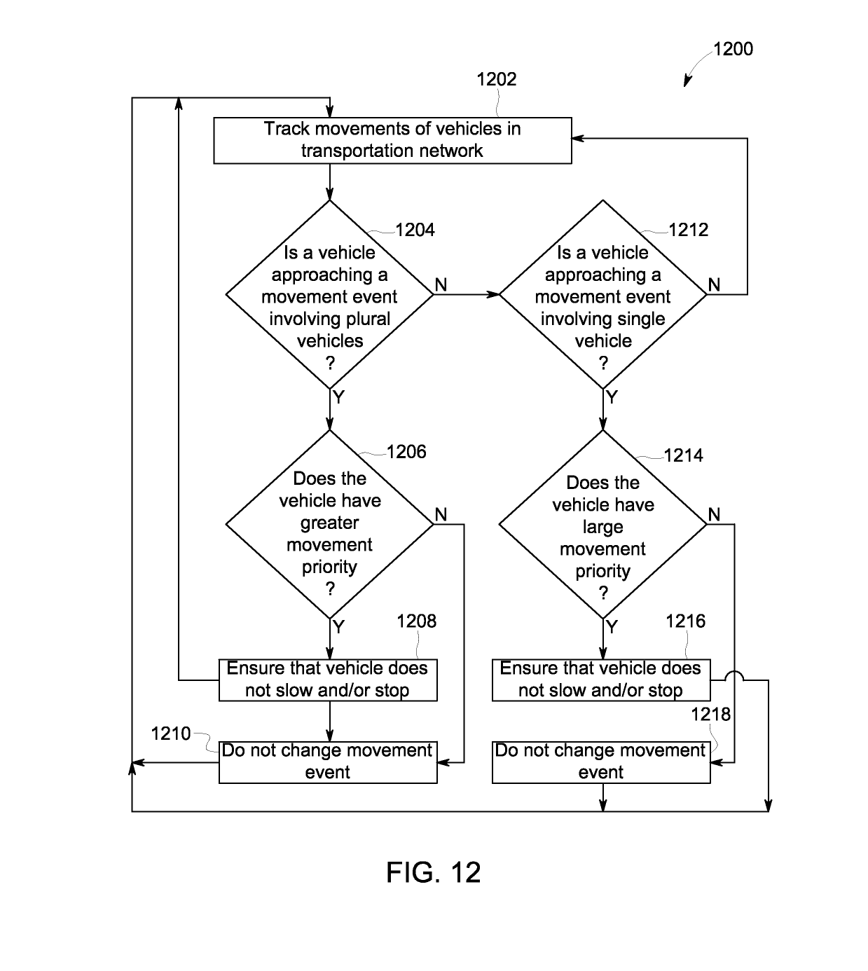

FIG. 12 is a flowchart of one embodiment of a method 1200 for controlling movement of vehicles in a transportation network. The method 1200 may be used to control the movement of the vehicles 104 (shown in FIG. 1) based on the size and/or mass of the vehicles 104, the amounts of fuel consumed by the vehicles 104 during movement events, and/or the amounts of kinetic energy losses of the vehicles 104 during the movement events while the vehicles 104 are moving, as described herein. Reference is made to several components illustrated in the accompanying Figures without limiting the method 1200 to the illustrated embodiments.

At 1202, movements of the vehicles 104 (shown in FIG. 1) in the transportation network 100 (shown in FIG. 1) can be tracked. For example, the vehicles 104 may include Global Positioning System receivers that obtain locations of the vehicles 104 and the vehicles 104 may transmit the locations to the system that is monitoring the vehicle movements (e.g., the scheduling system 110 shown in FIG. 1). Alternatively, wayside devices 132 (shown in FIG. 1) may notify the system that is monitoring the vehicle movements when vehicles 104 pass the wayside devices 132.

At 1204, a determination is made as to whether a vehicle 104 (shown in FIG. 1) is approaching a movement event involving plural vehicles 104. For example, a determination may be made as to whether a vehicle 104 is approaching another vehicle 104 too quickly (e.g., in such a manner that could require the vehicle 104 to abruptly slow down), and/or whether the vehicle 104 is approaching a meet event, pass event, divergence event, or convergence event. The schedules of the vehicles 104 may be examined to determine the locations and/or times of the movement events. These locations and/or times can be compared to actual movements of the vehicles 104 to determine if and/or when a vehicle 104 approaches a movement event. If the vehicle 104 is approaching a movement event involving two or more vehicles 104, then the consumption parameter and/or movement priority of the vehicle 104 may be examined to determine if the movement event should be modified to conserve fuel. As a result, flow of the method 1200 can proceed to 1206. Alternatively, if the vehicle 104 is not approaching a movement event involving two or more vehicles 104, when flow of the method 1200 may proceed to 1212.

At 1206, the consumption parameter and/or movement priority of the vehicle 104 (shown in FIG. 1) is compared to the consumption parameters and/or movement priorities of the other vehicles 104 involved in the movement event. For example, the consumption parameters and/or movement priorities of the vehicles 104 involved in a meet or pass event can be compared to determine which vehicle 104 has a larger consumption parameter and/or movement priority. If the vehicle 104 being monitored has a larger consumption parameter and/or movement priority, flow of the method 1200 may proceed to 1208. On the other hand, if the vehicle 104 has a smaller consumption parameter and/or movement priority, then flow of the method 1200 may proceed to 1210.

At 1208, movement of the vehicle 104 (shown in FIG. 1) may be modified for the movement event such that the vehicle 104 does not slow and/or stop. For example, the vehicle 104 having the larger consumption parameter and/or movement priority may not slow down and/or stop for the movement event. If the vehicle 104 previously was scheduled to slow down and/or stop, then the schedule of the vehicle 104 may be modified while the vehicle 104 is moving, and/or one or more wayside devices 132 (shown in FIG. 1) may direct the vehicle 104 to continue without slowing and/or stopping. Flow of the method 1200 may return to 1202 where continued movement of the vehicle 104 may be tracked.

At 1210, movement of the vehicle 104 (shown in FIG. 1) may not be modified for the movement event such that the vehicle 104 does not slow and/or stop. If the vehicle 104 was not scheduled to slow and/or stop, then the vehicle 104 may continue to travel without slowing and/or stopping. Flow of the method 1200 may return to 1202 where continued movement of the vehicle 104 may be tracked.

At 1212, a determination is made as to whether a vehicle 104 (shown in FIG. 1) is approaching a movement event involving only the single vehicle 104 (and not another vehicle 104). For example, a determination may be made as to whether a vehicle 104 is approaching a bridge 122 (shown in FIG. 1) capable of being raised, a slow region 120 (shown in FIG. 1), and the like. If the vehicle 104 is approaching such a movement event, then the consumption parameter and/or movement priority of the vehicle 104 may be examined to determine if the movement event should be modified to conserve fuel. As a result, flow of the method 1200 can proceed to 1214. Alternatively, if the vehicle 104 is not approaching a movement event, when flow of the method 1200 may return to 1202 where continued movement of the vehicle 104 is tracked.

At 1214, the consumption parameter and/or movement priority of the vehicle 104 (shown in FIG. 1) is examined to determine if the movement of the vehicle 104 should be modified to conserve fuel. For example, the consumption parameter and/or movement priority of the vehicle 104 may be compared to one or more designated thresholds. If the vehicle 104 has a larger consumption parameter and/or higher movement priority, flow of the method 1200 may proceed to 1216. On the other hand, if the vehicle 104 has a smaller consumption parameter and/or movement priority, then flow of the method 1200 may proceed to 1218.

At 1216, movement of the vehicle 104 (shown in FIG. 1) may be modified for the movement event. For example, if the vehicle 104 is approaching another vehicle 104 too quickly, a signal wayside device 132c (shown in FIG. 1) may be actuated to direct the approaching vehicle 104 to slow down before coming too close to the vehicle 104 and being forced to abruptly slow down, as described above. Alternatively, a switch wayside device 132a (shown in FIG. 1) may be actuated to cause the vehicle 104 to travel on another route 102 that bypasses the movement event. In another example, the signal wayside device 132c may be actuated to direct the vehicle 104 to slow down to permit a raised bridge 122 (shown in FIG. 1) to lower before the vehicle 104 arrives at and crosses the bridge 122. Alternatively, a wayside device 132 may lower the raised bridge 122 before the vehicle 104 arrives at the bridge 122. Flow of the method 1200 may return to 1202 where continued movement of the vehicle 104 may be tracked.

At 1218, movement of the vehicle 104 (shown in FIG. 1) may not be modified for the movement event. Flow of the method 1200 may return to 1202 where continued movement of the vehicle 104 may be tracked.

In another embodiment, a system is provided that includes an energy module and a scheduling module. The energy module is configured to determine a first consumption parameter representative of a first amount of energy expended by a first vehicle during a movement event involving the first vehicle as the first vehicle moves along a route toward a destination location. For example, the energy module may be configured to determine the first consumption parameter as representative of a first amount of energy projected or estimated to be expended by the first vehicle when the first vehicle encounters (takes part in) the movement event at a future point in time, based on how the vehicle would experience the movement event according to its current operating mode or trajectory. The scheduling module is configured to receive the first consumption parameter from the energy module and to at least one of create or modify a first schedule for the first vehicle to move along the route based on the first consumption parameter. In another embodiment, another system is provided that includes an energy module and a scheduling module. The energy module is configured to determine a first consumption parameter representative of a first amount of energy that is projected to be expended by a first vehicle during an upcoming movement event involving the first vehicle. The energy module is configured to determine the first consumption parameter as the first vehicle moves along a route toward a destination location and prior to the first vehicle taking part in the upcoming movement event. The scheduling module is configured to receive the first consumption parameter from the energy module and to at least one of create or modify a first schedule for the first vehicle to move along the route based on the first consumption parameter.

In another aspect, the energy module is configured to determine a second consumption parameter representative of a second amount of energy that is projected to be expended by a second vehicle if the second vehicle were to take part in the upcoming movement event. The upcoming movement event involves the first vehicle and also the second vehicle.

In another aspect, the scheduling module is configured to receive the second consumption parameter and to at least one of create or modify the first schedule for the first vehicle based on a comparison between the first consumption parameter and the second consumption parameter.

In another aspect, the scheduling module is configured to assign movement priorities to the first vehicle and the second vehicle based on a comparison of the first consumption parameter and the second consumption parameter. The movement priorities are used by the scheduling module to at least one of create or modify the first schedule.

In another aspect, the scheduling module is configured to schedule which of the first vehicle or the second vehicle at least one of slows down or stops during the upcoming movement event based on the comparison of the first consumption parameter and the second consumption parameter.

In another aspect, the energy module is configured to determine the first consumption parameter based on a mass of the first vehicle.

In another aspect, the energy module is configured to determine the first consumption parameter based on an amount of kinetic energy that is projected to be lost by the first vehicle if the first vehicle were to at least one of slow or stop during the upcoming movement event.

In another aspect, the energy module is configured to determine the first consumption parameter based on an amount of fuel or electrical energy that is projected to be consumed by the first vehicle if the first vehicle were to accelerate after at least one of slowing or stopping during the upcoming movement event.

In another aspect, the energy module is configured to determine the first consumption parameter based on a cost of the fuel or electrical energy.

In another aspect, the upcoming movement event includes at least one of a meet event between the first vehicle and a second vehicle traveling along a common direction along the route, a pass event between the first vehicle and the second vehicle traveling in opposite directions along the route, a convergence event between the first vehicle traveling on the route and the second vehicle traveling on a merging route that merges with the route, or a divergence event between the first vehicle and the second vehicle traveling on the route toward diverging routes.

In another aspect, the upcoming movement event includes changing a speed of the first vehicle in response to at least one of actuation of a signaling wayside device disposed alongside the route, changing position of a switch wayside device at an intersection between the route and at least one other route, approaching a section of the route associated with a reduced speed limit, approaching a section of the route under repair, or approaching a section of the route that is at least temporarily unavailable for the first vehicle to travel along.

In another aspect, the system also includes an output module that is configured to provide an output signal to at least one of the first vehicle or a signaling wayside device disposed alongside the route based on the first consumption parameter. The output signal is used to at least one of automatically control tractive effort of the first vehicle, notify an operator of the first vehicle how to control the tractive effort of the first vehicle, or actuate the signaling wayside device to direct the operator of the first vehicle to control the tractive effort of the first vehicle.

In another aspect, the system also includes an output module that is configured to provide an output signal to a maintenance system that schedules at least one of maintenance or repair to a section of the route. The output signal directs the maintenance system to delay the at least one of maintenance or repair of the section of the route.

In another embodiment, a method is provided that includes determining a first consumption parameter that is representative of a first amount of energy expended by a first vehicle during a movement event involving the first vehicle as the first vehicle moves along a route toward a destination location. For example, the first consumption parameter may be representative of a first amount of energy that is projected or estimated to be expected by the first vehicle when the first vehicle takes part in the movement event at a future point in time. The method also includes creating or modifying a first schedule for the first vehicle to move along the route based on the first consumption parameter. In another embodiment, another method is provided that includes determining a first consumption parameter that is representative of a first amount of energy that is projected to be expended by a first vehicle during an upcoming movement event involving the first vehicle. The first amount of energy is determined as the first vehicle moves along a route toward a destination location and prior to the first vehicle taking part in the upcoming movement event. The method also includes creating or modifying a first schedule for the first vehicle to move along the route based on the first consumption parameter.

In another aspect, determining the first consumption parameter includes determining a second consumption parameter representative of a second amount of energy that is projected to be expended by a second vehicle that also takes part in the upcoming movement event.

In another aspect, creating or modifying the first schedule includes comparing the first consumption parameter and the second consumption parameter.

In another aspect, the method also includes assigning movement priorities to the first vehicle and the second vehicle based on a comparison of the first consumption parameter and the second consumption parameter, and creating or modifying the first schedule includes basing the first schedule on one or more of the movement priorities.

In another aspect, creating or modifying the first schedule includes scheduling which of the first vehicle or the second vehicle at least one of slows down or stops during the upcoming movement event based on the comparison of the first consumption parameter and the second consumption parameter.

In another aspect, the first consumption parameter is based on at least one of a mass of the first vehicle, an amount of kinetic energy that is projected to be lost by the first vehicle if the first vehicle were to at least one of slows or stops during the upcoming movement event, an amount of fuel or electrical energy that is projected to be consumed by the first vehicle if the first vehicle were to accelerate after at least one of slowing or stopping during the upcoming movement event, or a cost of fuel or electrical energy that is projected to be consumed by the first vehicle if the first vehicle were to accelerate after at least one of slowing or stopping during the upcoming movement event.

In another embodiment, another system is provided that includes a control module. The control module is configured to be disposed on-board a first vehicle and communicatively coupled with at least one of a propulsion subsystem of the first vehicle or an output device disposed on-board the first vehicle. The control module is configured to receive an output signal from a scheduling module that generates the output signal based on a consumption parameter associated with the first vehicle. The consumption parameter is based on an amount of energy that is projected to be expended by the first vehicle during an upcoming movement event involving the first vehicle as the first vehicle moves along a route from a starting location to a destination location and prior to the first vehicle taking part in the upcoming movement event. The control module is configured to at least one of automatically control movement of the first vehicle or provide a notification to an operator of the first vehicle using the output device to direct the operator to control the movement of the first vehicle based on the output signal.

In another aspect, the first consumption parameter is based on at least one of a mass of the first vehicle, an amount of kinetic energy that is projected to be lost by the first vehicle if the first vehicle were to at least one of slows or stops during the upcoming movement event, an amount of fuel or electrical energy that is projected to be consumed by the first vehicle if the first vehicle were to accelerate after at least one of slowing or stopping during the movement event, or a cost of fuel or electrical energy that is projected to be consumed by the first vehicle if the first vehicle were to accelerate after at least one of slowing or stopping during the movement event.

In another aspect, the upcoming movement event includes at least one of a meet event between the first vehicle and a second vehicle traveling along a common direction along the route, a pass event between the first vehicle and the second vehicle traveling in opposite directions along the route, a convergence event between the first vehicle traveling on the route and the second vehicle traveling on a merging route that merges with the route, or a divergence event between the first vehicle and the second vehicle traveling on the route toward diverging routes.

In another aspect, the upcoming movement event includes changing a speed of the first vehicle in response to at least one of actuation of a signaling wayside device disposed alongside the route, changing position of a switch wayside device at an intersection between the route and at least one other route, approaching a section of the route associated with a reduced speed limit, approaching a section of the route under repair, or approaching a section of the route that is at least temporarily unavailable for the first vehicle to travel along.

In another embodiment, another system that includes a control module is provided. The control module is configured to be communicatively coupled with a wayside device that is disposed alongside a route traveled by a first vehicle. The control module also is configured to receive an output signal from a scheduling module that generates the output signal based on a consumption parameter associated with the first vehicle. The consumption parameter is based on an amount of energy that is projected to be expended by the first vehicle during an upcoming movement event involving the first vehicle as the first vehicle moves along the route from a starting location to a destination location and prior to the first vehicle taking part in the upcoming movement event. The control module also is configured to at least one of generate a signal or actuate a change in the route to provide a notification to an operator of the first vehicle to direct the operator to control the movement of the first vehicle based on the output signal.

In another aspect, the consumption parameter is based on at least one of a mass of the first vehicle, an amount of kinetic energy that is projected to be lost by the first vehicle if the first vehicle were to at least one of slow or stop during the movement event, an amount of fuel or electrical energy that is projected to be consumed by the first vehicle if the first vehicle were to accelerate after at least one of slowing or stopping during the movement event, or a cost of fuel or electrical energy that is projected to be consumed by the first vehicle if the first vehicle were to accelerate after at least one of slowing or stopping during the movement event.

In another aspect, the upcoming movement event includes at least one of a meet event between the first vehicle and a second vehicle traveling along a common direction along the route, a pass event between the first vehicle and the second vehicle traveling in opposite directions along the route, a convergence event between the first vehicle traveling on the route and the second vehicle traveling on a merging route that merges with the route, a divergence route between the first vehicle and the second vehicle traveling on the route toward diverging routes, or passage of the first vehicle over a bridge capable of being raised.

In another aspect, the control signal is configured to at least one of generate the signal to direct the operator to change a speed of the first vehicle, or change a position of a switch at an intersection between the route and at least one other route.

Another embodiment relates to a method, e.g., the method may be carried out by a system as described here, which is configured for performing the method. The method comprises a step of determining an estimated amount of energy that would be expended by a first vehicle (train, or rail vehicle, or other vehicle) upon taking part in a forthcoming movement event, as the first vehicle moves in a transportation network. For example, the forthcoming movement event could be a scheduled slowdown or stop at a moveable bridge, or a scheduled slowdown or stop at a siding to accommodate a meet-and-pass or overtake with a second vehicle. The amount of energy may be estimated as described above, e.g., based on the mass of the vehicle and change in velocity, or another method. The method further comprises a step of generating a control signal for controlling at least one of a second vehicle traveling in the network or a wayside device. The control signal is generated based on the estimated amount of energy, and is configured for the first vehicle to expend less energy during the movement event than the estimated amount when the second vehicle or wayside device is controlled according to the control signal and the first vehicle is controlled in coordination with the second vehicle or wayside device. Here, “configured” means timed and/or having control content such that if the second vehicle or wayside device is controlled according to the control signal, this allows (facilitates) the first vehicle to be controlled, in coordination, to use less energy (than the estimated amount) during the movement event.

In one example, the forthcoming movement event is a slowdown or stop of the first vehicle at a moveable bridge (broadly, a moveable bridge is a type of wayside device), which is planned or otherwise known of ahead of time. For example, it may be the case that: the moveable bridge is scheduled (at a forthcoming time, i.e., a future point in time) to be actuated to a position that would not allow the first vehicle to pass; the vehicle is scheduled to arrive at the moveable bridge at or around the forthcoming time; and because the vehicle cannot pass the bridge at that time, the vehicle would have to be slowed or stopped. (Thus, the forthcoming movement event is the vehicle slowing or stopping near the bridge.) The estimated amount of energy that would be expended by the vehicle in slowing or stopping at the bridge is determined as described above. Based on the estimated amount of energy (e.g., responsive to the estimated amount, and/or if the estimated amount is above a designated threshold), a control signal is generated for controlling the moveable bridge. The control signal is configured for the first vehicle to expend less energy during the movement event than the estimated amount when the moveable bridge is controlled according to the control signal and the first vehicle is controlled in coordination with the second vehicle or wayside device. In this example, the control signal may be: a control signal for actuating the bridge (to a position where it would interfere with the first vehicle), but delayed until after the first vehicle has passed the bridge (and, therefore, also delayed past the time when the bridge would have otherwise been actuated); a signal for modifying or creating a control schedule for automatically or otherwise actuating the bridge, e.g., a scheduled time for actuating the bridge is changed to a later time that is subsequent to when the vehicle will have passed the bridge location; or the like. Further in this example, coordinated control of the first vehicle (with regard to how the bridge is controlled according to the control signal) may comprise: not slowing or stopping the vehicle; slowing the vehicle, but less than the vehicle would have been slowed previously; or the like. For coordinated control of the first vehicle, information may be communicated to the first vehicle, such as: communicating a revised schedule; communicating a control signal for controlling the vehicle differently than it otherwise would have been controlled; controlling a wayside signaling device (e.g., controlling the wayside signaling device to display a green/unrestricted or yellow/caution aspect instead of a red/stop aspect); or the like.

In another embodiment of the method, the method comprises a step of determining a first estimated amount of energy that would be expended by a first vehicle upon taking part in a forthcoming movement event, and a second estimated amount of energy that would be expended by a second vehicle upon taking part in the forthcoming movement event. The method further comprises a comparison between the first estimated amount and the second estimated amount (the method comprises comparing the first estimated amount and the second estimated amount), and generating a first control signal for controlling the first vehicle (relative to the movement event) based on the comparison. The first control signal is configured such that when the first vehicle is controlled according to the control signal, the first vehicle expends less energy than the first estimated amount during the movement event. The method may further comprise generating a second control signal for controlling the second vehicle, in coordination with how the first vehicle is controlled according to the first control signal. The comparison may include an assessment of how adjusting movement of the first vehicle and/or the second vehicle, with respect to the movement event, would result in the most energy saved and/or the most economic value (money saved) versus the first estimated amount and the second estimated amount.

In another embodiment of a method, the method comprises determining a first estimated amount of energy to be expended by a first vehicle during a forthcoming movement event in a transportation network. The first estimated amount is determined based on a first schedule or trajectory of the first vehicle. The method further comprises, based on a second schedule or trajectory of a second vehicle, determining a second estimated amount of energy to be expended by the second vehicle during the forthcoming movement event. The method further comprises determining a change in the first schedule or trajectory that would result in the first vehicle expending a third estimated amount of energy during the movement event that is less than the first estimated amount. The method further comprises determining a fourth estimated amount of energy that would be expended by the second vehicle during the movement event if controlled to account for the change in the first schedule or trajectory. The method further comprises generating a control signal for controlling the first vehicle according to the change in the first schedule or trajectory, but only if a total amount of energy or a total value of the third and fourth estimated amounts in combination is less than a total amount of energy or a total value of the first and second estimated amounts in combination.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, controllers or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A system comprising:
an energy module configured to determine a first consumption parameter representative of a first amount of energy that is projected to be expended by a first vehicle during an upcoming movement event involving the first vehicle, the energy module configured to determine the first consumption parameter as the first vehicle moves along a route toward a destination location and prior to the first vehicle taking part in the upcoming movement event; and
a scheduling module configured to receive the first consumption parameter from the energy module and to at least one of create or modify a first schedule for the first vehicle to move along the route based on the first consumption parameter.

2. The system of claim 1, wherein the energy module is configured to determine a second consumption parameter representative of a second amount of energy that is projected to be expended by a second vehicle if the second vehicle were to take part in the upcoming movement event, the upcoming movement event involving the first vehicle and also the second vehicle.

3. The system of claim 2, wherein the scheduling module is configured to receive the second consumption parameter and to at least one of create or modify the first schedule for the first vehicle based on a comparison between the first consumption parameter and the second consumption parameter.

4. The system of claim 2, wherein the scheduling module is configured to assign movement priorities to the first vehicle and the second vehicle based on a comparison of the first consumption parameter and the second consumption parameter, and the movement priorities are used by the scheduling module to at least one of create or modify the first schedule.

5. The system of claim 2, wherein the scheduling module is configured to schedule which of the first vehicle or the second vehicle at least one of slows down or stops during the upcoming movement event based on the comparison of the first consumption parameter and the second consumption parameter.

6. The system of claim 1, wherein the energy module is configured to determine the first consumption parameter based on a mass of the first vehicle.

7. The system of claim 1, wherein the energy module is configured to determine the first consumption parameter based on an amount of kinetic energy that is projected to be lost by the first vehicle if the first vehicle were to at least one of slow or stop during the upcoming movement event.

8. The system of claim 1, wherein the energy module is configured to determine the first consumption parameter based on an amount of fuel or electrical energy that is projected to be consumed by the first vehicle if the first vehicle were to accelerate after at least one of slowing or stopping during the upcoming movement event.

9. The system of claim 8, wherein the energy module is configured to determine the first consumption parameter based on a cost of the fuel or electrical energy.

10. The system of claim 1, wherein the upcoming movement event includes at least one of a meet event between the first vehicle and a second vehicle traveling in opposite directions along the route, a pass event between the first vehicle and the second vehicle traveling in a common direction along the route, a convergence event between the first vehicle traveling on the route and the second vehicle traveling on a merging route that merges with the route, or a divergence event between the first vehicle and the second vehicle traveling on the route toward diverging routes.

11. The system of claim 1, wherein the upcoming movement event includes changing a speed of the first vehicle in response to at least one of actuation of a signaling wayside device disposed alongside the route, changing position of a switch wayside device at an intersection between the route and at least one other route, approaching a section of the route associated with a reduced speed limit, approaching a section of the route under repair, or approaching a section of the route that is at least temporarily unavailable for the first vehicle to travel along.

12. The system of claim 1, further comprising an output module configured to provide an output signal to at least one of the first vehicle or a signaling wayside device disposed alongside the route based on the first consumption parameter, wherein the output signal is used to at least one of automatically control tractive effort of the first vehicle, notify an operator of the first vehicle how to control the tractive effort of the first vehicle, or actuate the signaling wayside device to direct the operator of the first vehicle to control the tractive effort of the first vehicle.

13. The system of claim 1, further comprising an output module configured to provide an output signal to a maintenance system that schedules at least one of maintenance or repair to a section of the route, wherein the output signal directs the maintenance system to delay the at least one of maintenance or repair of the section of the route.

14. A method comprising:
determining a first consumption parameter that is representative of a first amount of energy that is projected to be expended by a first vehicle during an upcoming movement event involving the first vehicle, the first amount of energy determined as the first vehicle moves along a route toward a destination location and prior to the first vehicle taking part in the upcoming movement event; and
creating or modifying a first schedule for the first vehicle to move along the route based on the first consumption parameter.

15. The method of claim 14, wherein determining the first consumption parameter includes determining a second consumption parameter representative of a second amount of energy that is projected to be expended by a second vehicle that also takes part in the upcoming movement event.

16. The method of claim 15, wherein creating or modifying the first schedule includes comparing the first consumption parameter and the second consumption parameter.

17. The method of claim 15, further comprising assigning movement priorities to the first vehicle and the second vehicle based on a comparison of the first consumption parameter and the second consumption parameter, and creating or modifying the first schedule includes basing the first schedule on one or more of the movement priorities.

18. The method of claim 15, wherein creating or modifying the first schedule includes scheduling which of the first vehicle or the second vehicle at least one of slows down or stops during the upcoming movement event based on the comparison of the first consumption parameter and the second consumption parameter.

19. The method of claim 14, wherein the first consumption parameter is based on at least one of a mass of the first vehicle, an amount of kinetic energy that is projected to be lost by the first vehicle if the first vehicle were to at least one of slow or stop during the upcoming movement event, an amount of fuel or electrical energy that is projected to be consumed by the first vehicle if the first vehicle were to accelerate after at least one of slowing or stopping during the upcoming movement event, or a cost of fuel or electrical energy that is projected to be consumed by the first vehicle if the first vehicle were to accelerate after at least one of slowing or stopping during the upcoming movement event.

20. A method comprising:
determining an estimated amount of energy that would be expended by a first vehicle taking part in a forthcoming movement event as the first vehicle moves in a transportation network; and
based on the estimated amount, generating a control signal for controlling at least one of a second vehicle traveling in the network or a wayside device,
wherein the control signal is configured for the first vehicle to expend less energy during the movement event than the estimated amount when the second vehicle or wayside device is controlled according to the control signal and the first vehicle is controlled in coordination with the second vehicle or wayside device.

21. A system comprising:
a control module configured to be disposed on-board a first vehicle and communicatively coupled with at least one of a propulsion subsystem of the first vehicle or an output device disposed on-board the first vehicle,
wherein the control module is configured to receive an output signal from a scheduling module that generates the output signal based on a consumption parameter associated with the first vehicle, the consumption parameter based on an amount of energy that is projected to be expended by the first vehicle during an upcoming movement event involving the first vehicle as the first vehicle moves along a route from a starting location to a destination location and prior to the first vehicle taking part in the upcoming movement event, and
wherein the control module is configured to at least one of automatically control movement of the first vehicle or provide a notification to an operator of the first vehicle using the output device to direct the operator to control the movement of the first vehicle based on the output signal.

22. The system of claim 21, wherein the first consumption parameter is based on at least one of a mass of the first vehicle, an amount of kinetic energy that is projected to be lost by the first vehicle if the first vehicle were to at least one of slows or stops during the upcoming movement event, an amount of fuel or electrical energy that is projected to be consumed by the first vehicle if the first vehicle were to accelerate after at least one of slowing or stopping during the movement event, or a cost of fuel or electrical energy that is projected to be consumed by the first vehicle if the first vehicle were to accelerate after at least one of slowing or stopping during the movement event.

23. The system of claim 21, wherein the upcoming movement event includes at least one of a meet event between the first vehicle and a second vehicle traveling in opposite directions along the route, a pass event between the first vehicle and the second vehicle traveling in a common direction along the route, a convergence event between the first vehicle traveling on the route and the second vehicle traveling on a merging route that merges with the route, or a divergence event between the first vehicle and the second vehicle traveling on the route toward diverging routes.

24. The system of claim 21, wherein the upcoming movement event includes changing a speed of the first vehicle in response to at least one of actuation of a signaling wayside device disposed alongside the route, changing position of a switch wayside device at an intersection between the route and at least one other route, approaching a section of the route associated with a reduced speed limit, approaching a section of the route under repair, or approaching a section of the route that is at least temporarily unavailable for the first vehicle to travel along.

25. A system comprising:
a control module configured to be communicatively coupled with a wayside device that is disposed alongside a route traveled by a first vehicle,
wherein the control module is configured to receive an output signal from a scheduling module that generates the output signal based on a consumption parameter associated with the first vehicle, the consumption parameter based on an amount of energy that is projected to be expended by the first vehicle during an upcoming movement event involving the first vehicle as the first vehicle moves along the route from a starting location to a destination location and prior to the first vehicle taking part in the upcoming movement event, and
wherein the control module is configured to at least one of generate a signal or actuate a change in the route to provide a notification to an operator of the first vehicle to direct the operator to control the movement of the first vehicle based on the output signal.

26. The system of claim 25, wherein the consumption parameter is based on at least one of a mass of the first vehicle, an amount of kinetic energy that is projected to be lost by the first vehicle if the first vehicle were to at least one of slow or stop during the movement event, an amount of fuel or electrical energy that is projected to be consumed by the first vehicle if the first vehicle were to accelerate after at least one of slowing or stopping during the movement event, or a cost of fuel or electrical energy that is projected to be consumed by the first vehicle if the first vehicle were to accelerate after at least one of slowing or stopping during the movement event.

27. The system of claim 25, wherein the upcoming movement event includes at least one of a meet event between the first vehicle and a second vehicle traveling in opposite directions along the route, a pass event between the first vehicle and the second vehicle traveling in a common direction along the route, a convergence event between the first vehicle traveling on the route and the second vehicle traveling on a merging route that merges with the route, a divergence route between the first vehicle and the second vehicle traveling on the route toward diverging routes, or passage of the first vehicle over a bridge capable of being raised.

28. The system of claim 25, wherein the control signal is configured to at least one of generate the signal to direct the operator to change a speed of the first vehicle, or change a position of a switch at an intersection between the route and at least one other route.
